(19) United States
(12) Patent Application Publication
(10) Pub. No.: US 2026/0363232 A1
(43) Pub. Date: Nov. 19, 2026

(54) SYSTEM AND METHOD FOR DETERRING ANIMALS

(71) Applicant: OrniLogic, LLC, Kalamazoo, MI (US)

(72) Inventor: Timothy A. Shields, Joshua Tree, CA (US)

(21) Appl. No.: 19/679,450

(22) Filed: May 15, 2026

Related U.S. Application Data
(60) Provisional application No. 63/807,341, filed on May 16, 2025.

(51) Int. Cl. A01M 29/10; A01M 29/18

(52) U.S. Cl. CPC A01M 29/10; A01M 29/18

(57) ABSTRACT

Systems and methods are disclosed for deterring animals from electrical infrastructure. A deterrent system includes a sensor for detecting and tracking a target, a laser and a sound emitter used to deter undesired animals, and a bracket for mounting the deterrent system to the infrastructure.

### CROSS REFERENCE TO RELATED APPLICATION

The present application claims priority to U.S. Provisional Application No. 63/807,341 entitled SYSTEM AND METHOD FOR DETERRING ANIMALS filed May 16, 2025. The entire content of the above application is hereby incorporated by reference for all purposes.

### TECHNICAL FIELD

Embodiments of the subject matter disclosed herein relate to a system and method for deterring birds and/or other undesired animals from specific components and features of equipment, such as electric utility structures.

### BACKGROUND AND SUMMARY

Infrastructure, such as electrical distribution infrastructure, may be prone to degradation from multiple sources. For example, birds and other animals may perch or nest on electrical infrastructure such as live wires, insulators of electrical poles, and transformers, which may cause degradation to the infrastructure, and in some cases harm to the animal. As another example, birds constructing nests at a site may cause fire hazards through short circuits or actively degrade infrastructure near the site due to the effect of physical contact between birds and conductors and the deposition of fecal material and other materials.

The inventors have identified the above-mentioned issues and present herein a system and method that at least partially solves the identified issues. In one example, an animal deterrent system includes a laser system, a sound emitter, a sensor, and a control system. The sensor may detect motion of an object. In response, the control system may command the sound emitter to emit one or more sounds, which may be based on the identity of the detected object, and following a delay if the object has not vacated the area within detection range of the sensor, the control system may command the laser to direct a beam at the object. In this way, over time, animals may learn to associate the negative experience of being targeted by the laser beam with the sounds that precede the beam, such that the animals may in subsequent encounters with the deterrent system be deterred by the sound alone. In at least some examples, the control system may identify the object as an undesired animal before generating the sound and laser beam, so as to avoid deterring desired or neutral animals or causing annoyance to humans. In this way, the deterrent system provided herein may be selective as to the targets of the sounds and laser beam.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a schematic of an example of a site monitored via a Nest Abandonment Induction Laser (NAIL) system that includes a speaker, a laser, and a sensor;

FIG. 2 shows a schematic of an example of a site monitored via the NAIL system;

FIG. 3 shows a schematic of an example of a site monitored via the NAIL system with a data transmission system for communicatively coupling the NAIL system to a control station;

FIG. 4 shows a schematic of the NAIL system communicatively coupled to a user system;

FIG. 5 shows a side view of a laser assembly and a bracket of the NAIL system;

FIG. 6 shows a side view of the laser assembly;

FIG. 7 shows an exploded view of the laser assembly;

FIG. 8 shows a side view of the laser assembly;

FIG. 9 shows a sectional view of a housing unit for the laser assembly;

FIG. 10 shows a sectional view of the housing unit for the laser assembly;

FIG. 11 shows a side view of a backing for the laser assembly;

FIG. 12 shows a side view of the backing;

FIG. 13 shows a sectional view of the backing;

FIG. 14 shows a flowchart of a method of deterring a target via the NAIL system;

FIG. 15 shows a flowchart of a method of deterring a target via the NAIL system using machine learning to identify the target;

FIG. 16 shows a side view and perspective view of a partially transparent laser assembly;

FIG. 17 shows a sectional view of the housing unit;

FIGS. 18A and 18B show another example of a NAIL system; and

FIGS. 19A-19G show individual components of the NAIL system of FIGS. 18A and 18B.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

Methods and systems are provided herein for a deterrent system for deterring animals from infrastructure, such as an electrical distribution system. The deterrent system, also referred to herein as a Nest Abandonment Induction Laser (NAIL) system, includes at least a sensor, a laser or another dissuasion device, and a sound emitter that are mountable to an electrical pole, tower, sub-station, or the like.

Previous deterring methods include applying a laser output directed at the undesired objects, such as birds and other animals. Such lasers may be automatic (e.g., motion activated), human operated, or a hybrid of the two. However, targeting and firing of the laser based on motion detection may be indiscriminate, resulting in a beam deterring animals that are neutral or beneficial to have near a site. Further, it may be desired for a bird to be deterred in a different manner that does not cause irritation or harm to the targeted bird. Additionally or alternatively to the laser, sound may be used to deter birds by increasing the likelihood of a fear response or through annoyance, but principally by association of the sound with a negative experience. However, using sounds of a high decibel may hinder the ability of human operators to work at a site or irritate nearby human residents, or employees and/or owners of commercial businesses. Further, sounds may deter and be a stressor to neutral or desired animals. For example, a desired animal, such as a beaver, may build dams and estuaries that may reduce the likelihood of wildfires and may reduce heat near a site, which may reduce degradation to systems and apparatuses at the site. Further, an undesired animal may habituate, becoming comfortable with the sound over time, or may realize that there is not a reason to be deterred by the sound alone because the sound does not cause harm.

The animal deterrent system, or NAIL system, provided herein may solve at least some of the issues with such previous systems. The speaker may emit sounds in order to communicate to the undesired species that a negative experience is imminent. For a first example, the sound may be a sound specifically designed via association to deter a bird or another animal, such as a sound that may induce a fear response (e.g., a sound of a predator for the animal) or a sound that is obnoxious or annoying to the animal. However, it is to be appreciated, the sound itself need not be frightening or obnoxious to be effective, but by way of preceding a strong negative experience, such as a beam from the laser of the NAIL system, serves as a cue after a training period during which the animal learns an association between the sound and negative experience, that the area should be vacated. Neutral or beneficial species that are not the target of aversive actions will likely not associate the sound with a bad experience and may not flee. The sound may be unnoticed by humans and neutral or desired animals, but repulsive to undesired species due to their association of the sound with prior negative experiences. Further, the sound frequency or physically focused sound emission, may be selected to be audible to undesired species of animal and may reduce audibility for desired species of animals or neutral species of animals. In this way, specificity of effect may be achieved. Further specificity can be achieved by positioning the NAIL unit in a location known to be frequently visited by the undesired species and not desired species. Additionally, the laser may selectively aim at undesired species, and avoid targeting desired and neutral species and humans. Additionally, the laser in the system may be multi-spectral allowing for multiple wavelengths of light to be projected. Wavelengths of light may be tailored to deter undesired species while avoiding deterrence of neutral or desired species of animals or discomfort to humans.

The sensor may detect a source of motion and be used to track the source of motion. In an example, when motion is detected within a threshold distance of the sensor, the moving object may be marked as a target. The target may be tracked via the NAIL system. In response to the detected presence, a specific sound may be emitted by the speaker. The NAIL system may wait through a prescribed delay period after emitting the sound for the target to leave the area. After the duration of the delay has passed without the undesired species leaving, the laser or other beam emitter of the NAIL system may generate a beam of light and/or other particles or outputs toward the target. Alternatively, another dissuasion device may be used in place of the beam generator, such as a pellet launcher, or another projectile launcher, or a targeted liquid sprayer, that may create a negative experience for the target. A liquid sprayer may spray an irritant toward the target, for example.

The NAIL system may use various methods to identify a species based on signatures of light, visible or otherwise, detected by the sensor that may be specific to a species. Additionally or alternatively, the system could use sonic clues to identify the species. The system may also use a machine learning (ML), such as a specially trained neural network, or algorithm to identify a species of an animal and discriminate between different species. While the model described herein is a neural network model, it should be appreciated that in other embodiments, a different type of model could be used without departing from the scope of this disclosure. For example, the model could be a different type of artificial intelligence (AI), machine learning (ML), deep learning (DL) model, a statistical model, algorithmic model, or a different type of model. The identified animal may be classified as a target if the species is an undesired species, or a non-target if the detected animal belongs to a desired or neutral species. For example, the control system may access a species classification lookup table taking the identified species as an input to determine whether the identified species is undesired, neutral, or desired.

Further, with the neural network model or other ML assisted decision-making model, the NAIL system may select, from a store of options, a sound tailored to repel a specific undesired species to be emitted via the sound emitter. The sound may be specific to deter the specific undesired species. For example, the sound emitted may mimic the sound of a predatory animal that may prey upon the identified undesired species or other sound to instill an instinctual fear or flight response of the identified species.

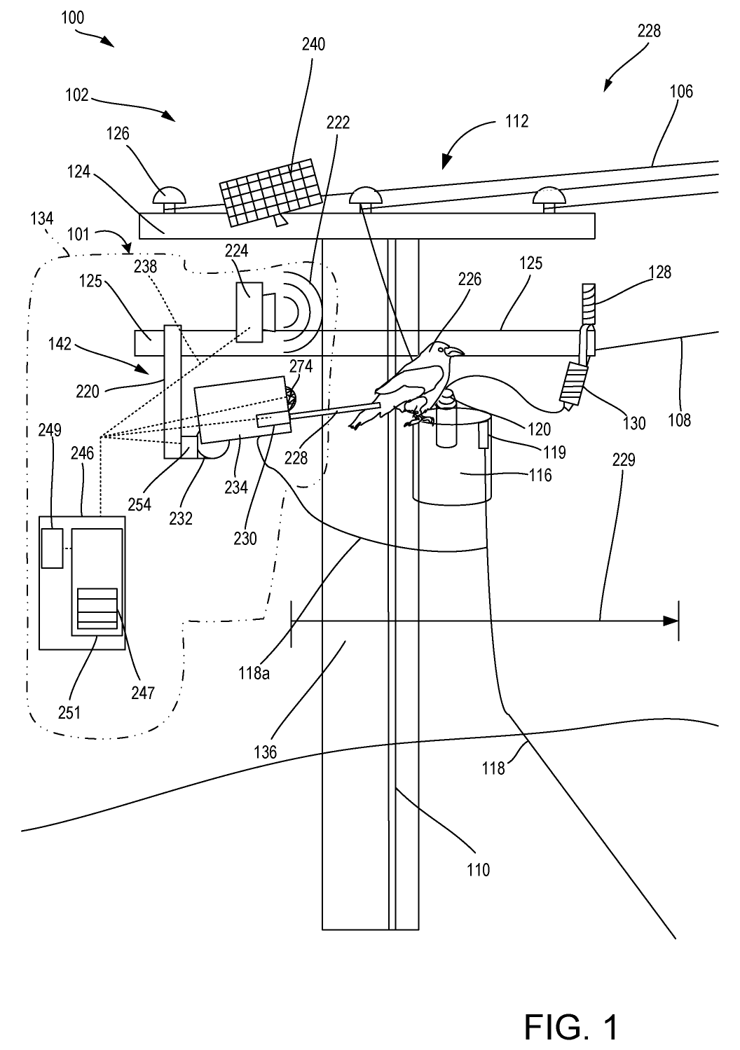

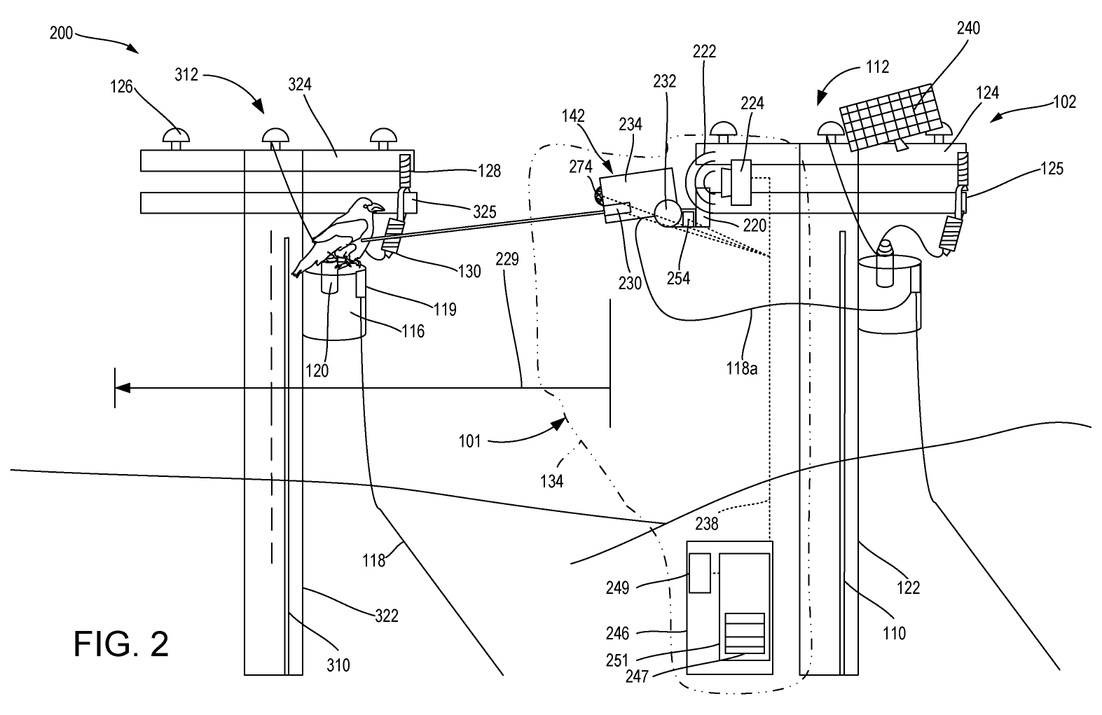

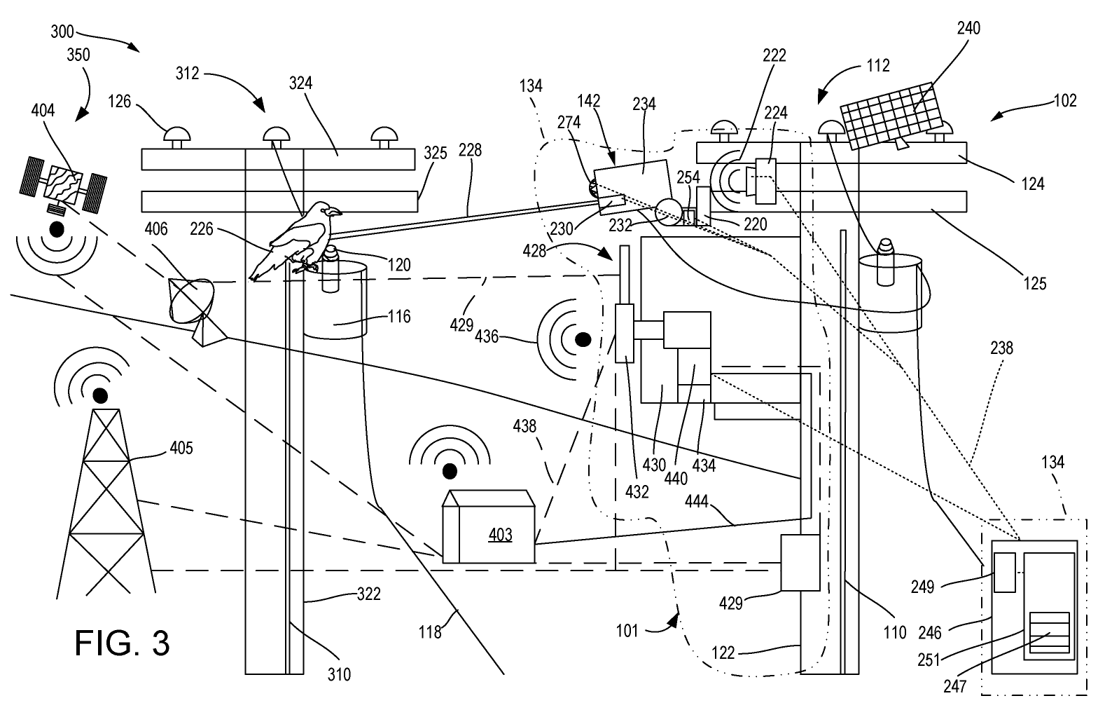

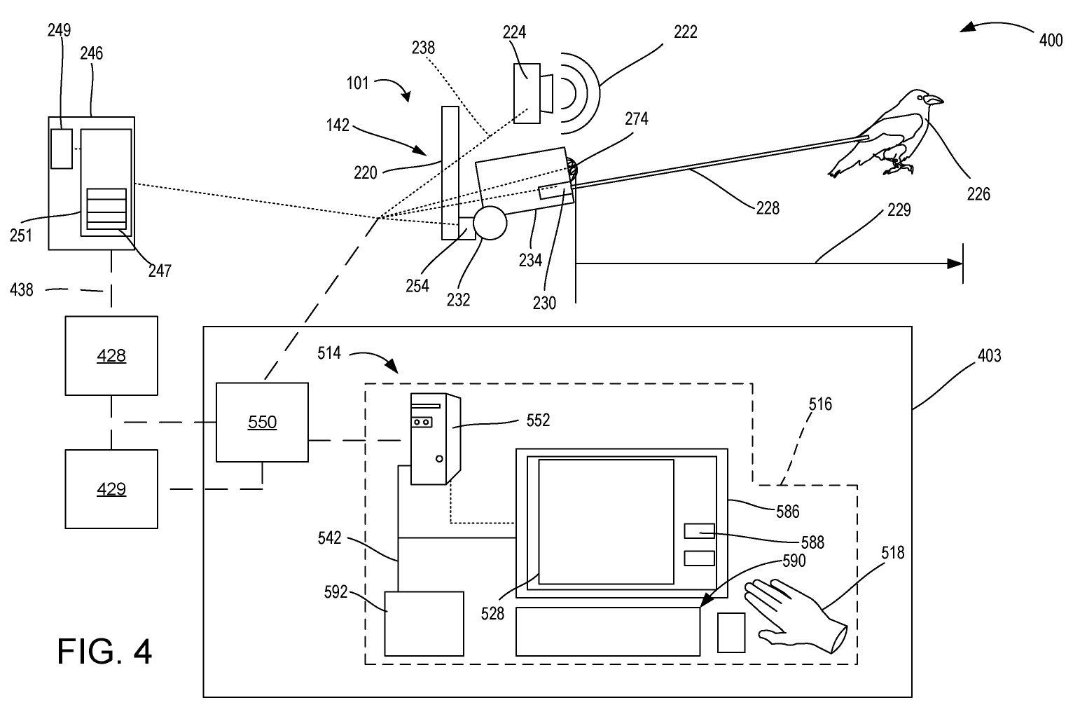

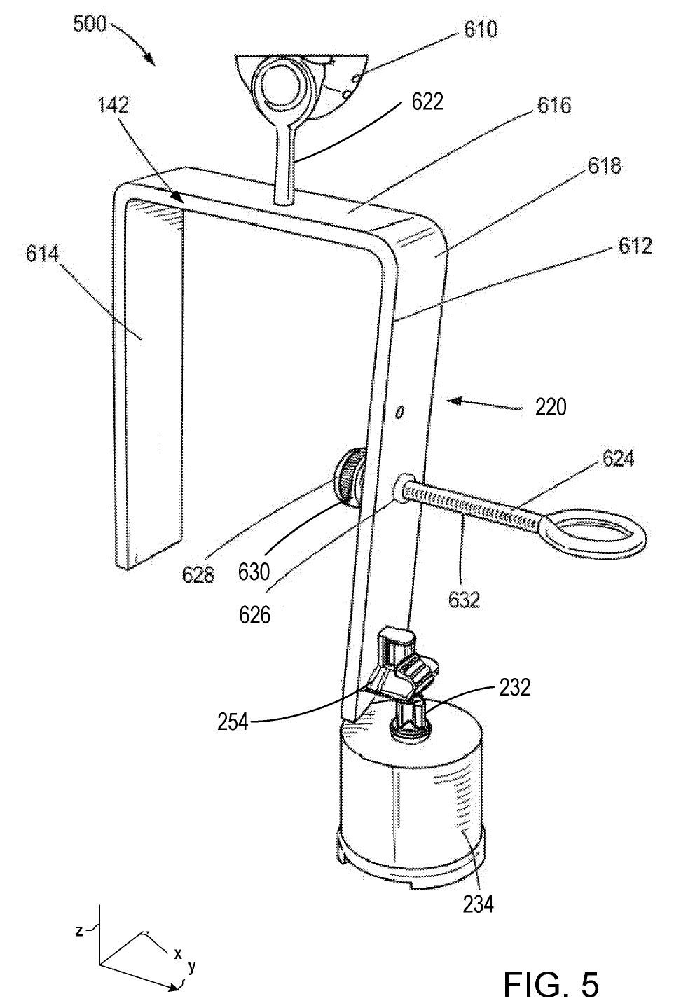

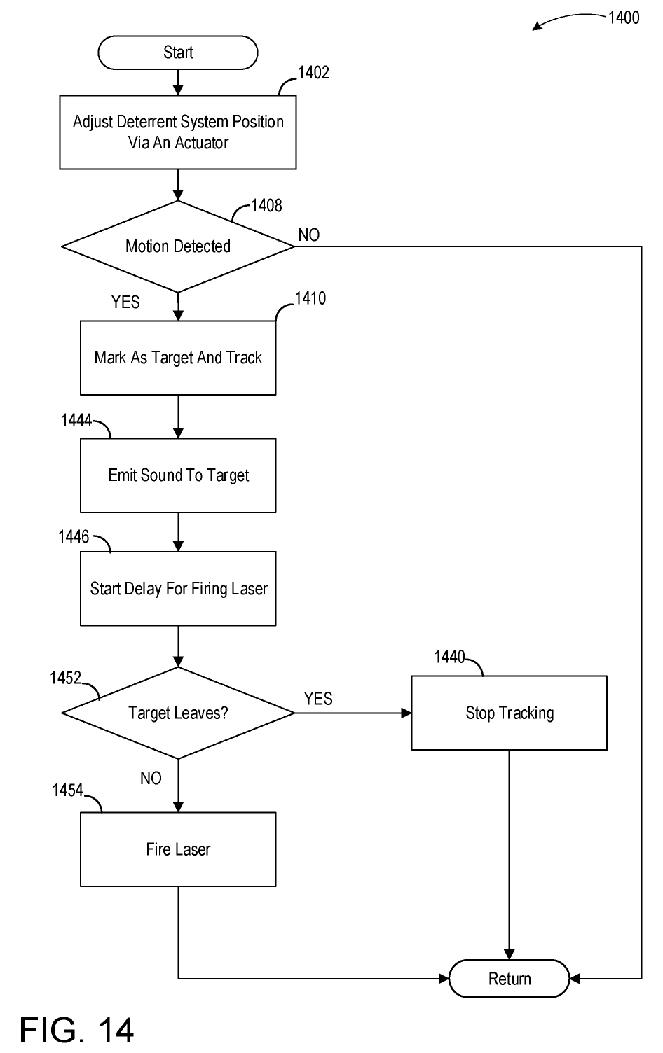

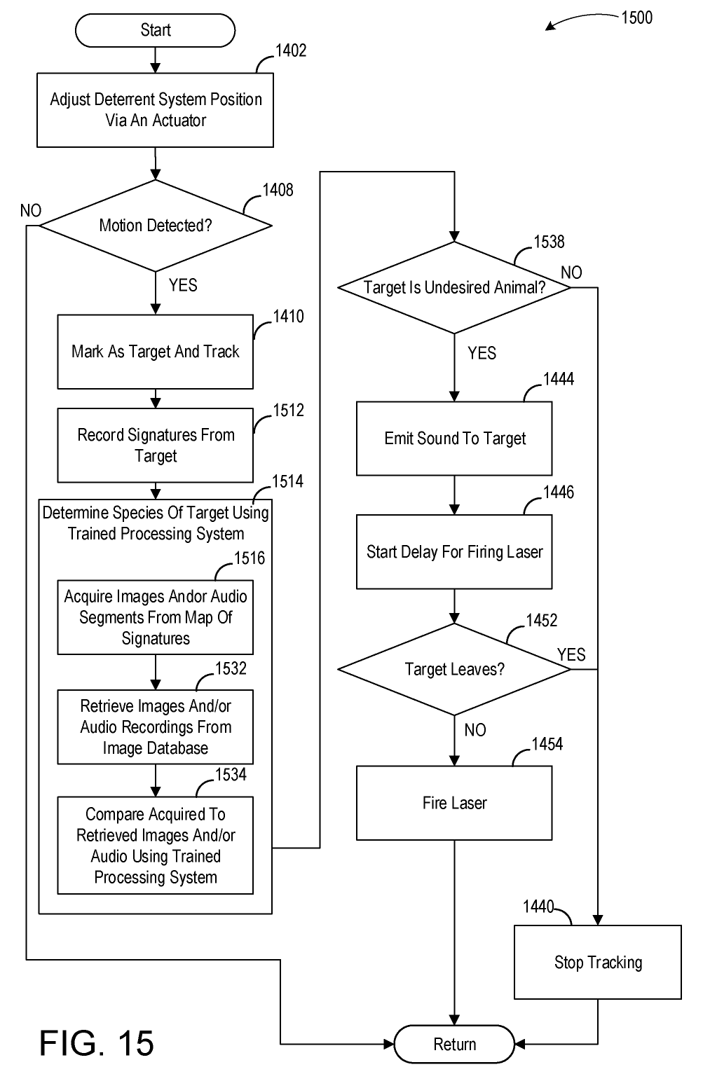

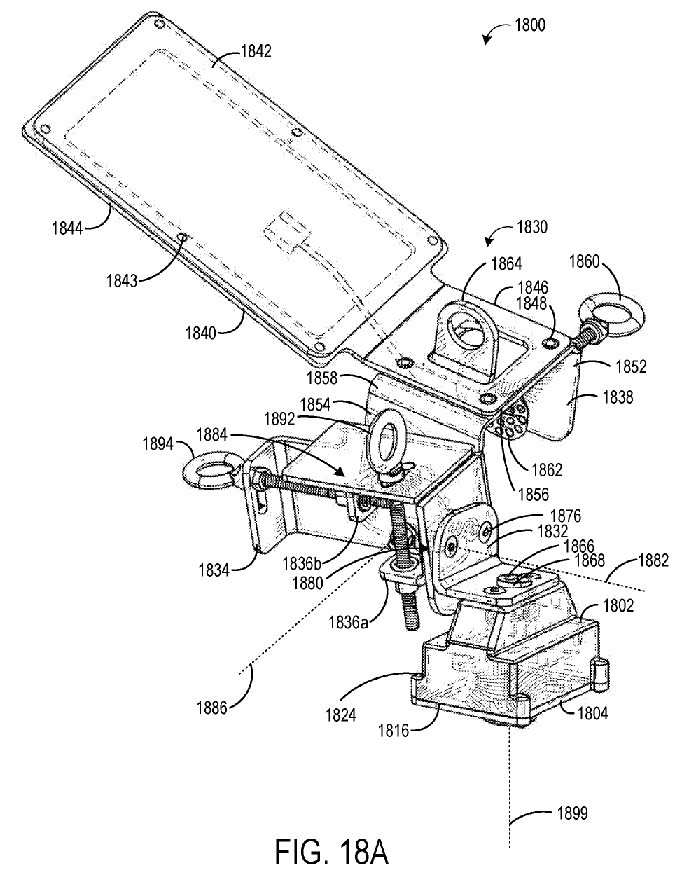

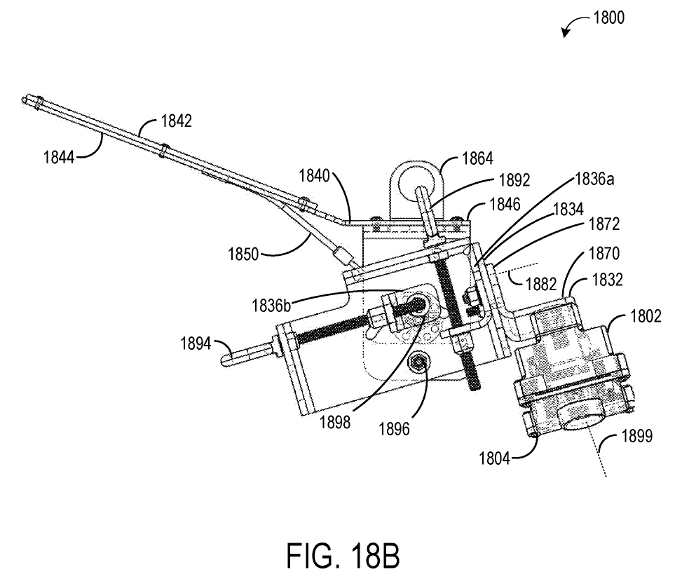

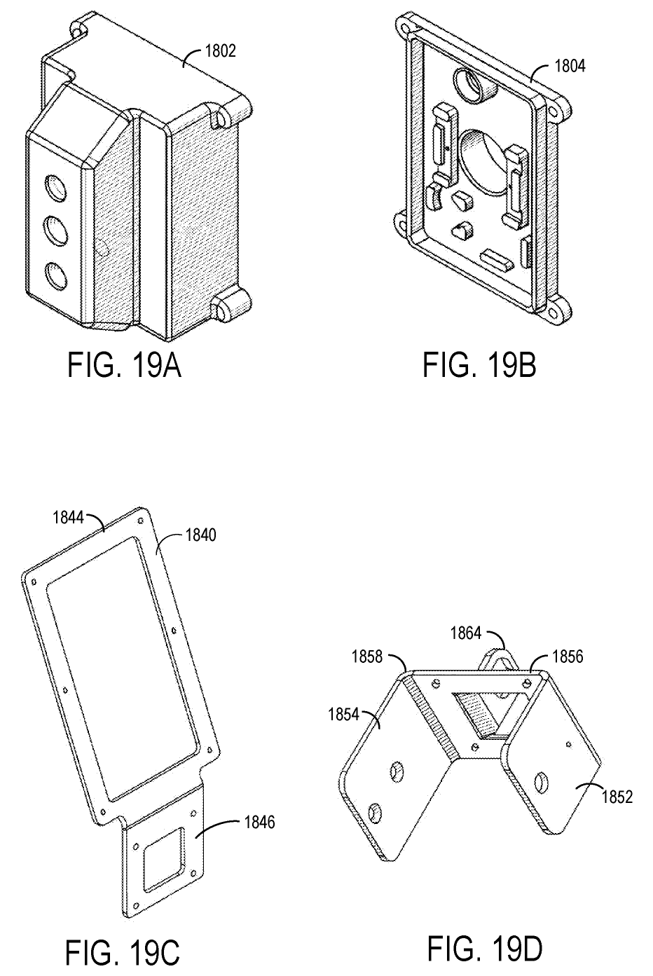

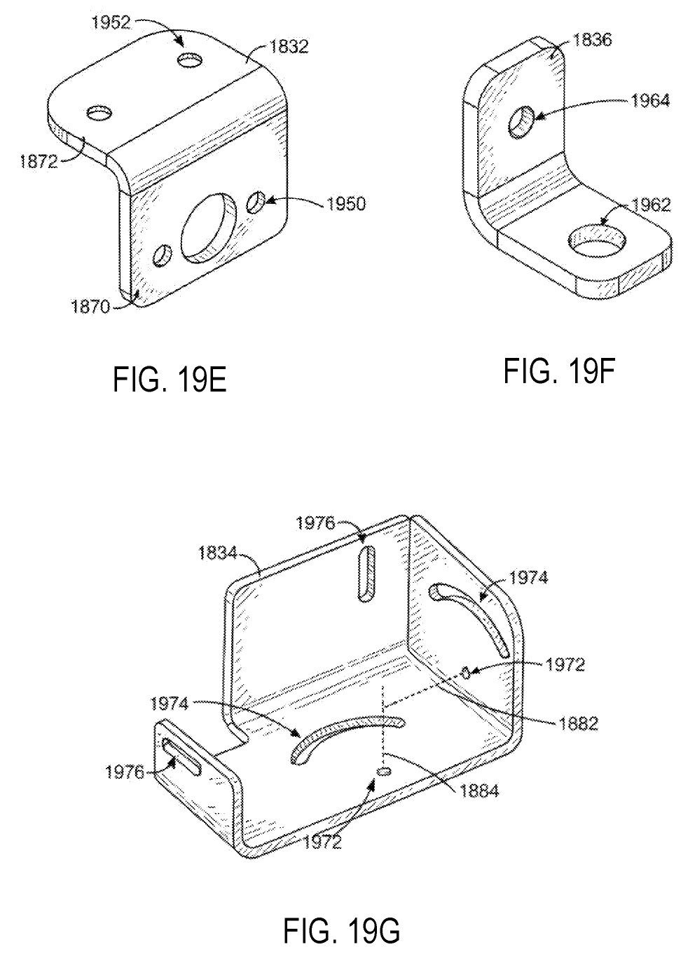

FIG. 1 shows a schematic of a system of infrastructure at a site monitored via the NAIL system. The infrastructure of FIG. 1 is an electrical distribution system including an electrical pole and components and features thereof. However, it is to be appreciated that alternatively the electrical pole may be an electrical transmission tower, substation, or other device. FIG. 2 shows a schematic of another example of a site monitored via the NAIL system. FIG. 3 shows a schematic of the site with a data transmission system for communicatively coupling the NAIL system and other devices mounted to the infrastructure to a control station. FIG. 4 shows a schematic of the NAIL system, a controller, and a user system. The user system may include a computer that a user may operate to remotely change settings of the of the NAIL system. FIGS. 5-13, 16 and 17 show various views of components of an example of the NAIL system. FIG. 14 shows a first example of a method of operating the NAIL system to deter a detected target, such as an undesired animal. FIG. 15 shows a second example of a method for operating the NAIL system, including identifying a target via detected signatures for more selective deterrence of undesired animals, rather than generally deterring all detected animals. FIGS. 18A and 18B show another example of a NAIL system, comprising a mounting bracket assembly. Components of the mounting bracket assembly are shown individually in FIGS. 19A-19G.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIGS. 1-13 and 16-19G show example configurations with approximate positioning of various components unless otherwise stated. FIGS. 5-13 and 16-19G are shown approximately to scale, although other relative dimensions may be used. As used herein, the term “approximately” is construed to mean plus or minus five percent of the range unless otherwise specified. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis unless otherwise specified. Features described as counter-axial may be approximately perpendicular to an axis unless otherwise specified. Features described as radial may circumferentially surround or extend outward from an axis unless otherwise specified.

Features described as longitudinal may be approximately parallel with an axis that is longitudinal. Features described as vertical may be approximately parallel with an axis that is vertical. An axis that is normal (e.g., perpendicular) to an axis that is longitudinal and vertical may be referred to as lateral. Features described as lateral may be approximately parallel with an axis that is lateral.

FIG. 1 shows a first schematic 100 of an electrical distribution system 102. One or more sites of the electrical distribution system 102 may be monitored by a laser system 142 to deter undesired objects, such as an undesired object 226. The undesired object 226 may be an animal. More specifically, the undesired object 226 may be an individual of a species that is undesired to be present within a threshold distance from the electrical distribution system 102.

The electrical distribution system 102 may comprise a plurality of structures including electrical poles, such as a first electrical pole 112. The first electrical pole 112 may include a first pole section 122, a first cross-arm 124, and a second cross-arm 125. Additional electrical poles of the system 102 may similarly include a pole section and at least one cross-arm.

The electrical poles of the electrical distribution system 102 may support a plurality of primary wires 106, one or more neutral wires 108, one or more grounding wire(s) 110, and one or more secondary wires 118. The primary wires 106 may deliver electricity from a substation along the electrical distribution system 102. The neutral wire 108 may balance electricity from the primary wires 106 and act as a line for electrical energy back to the substation. The grounding wire(s) 110 may form a grounding circuit with the neutral wire 108, grounding the neutral wire 108 and a respective pole, such as the first electrical pole 112.

One or more insulators 126 may be mounted to a cross-arm of the electrical pole 112, such as the first cross-arm 124 as shown in the schematic of FIG. 1. Each of the insulators 126 may support and be coupled to one of the primary wires 106. The insulators 126 may prevent the primary wires 106 from electrically coupling to certain components of the first electrical pole 112, such as the pole section 122 and the cross-arms 124, 125.

Each of the secondary wires 118 may be electrically coupled to a transformer, such as the first transformer 116 which is mounted to the first electrical pole 112, via one or more electrical couplings 119. The transformer 116 and other transformers of the electrical distribution system 102 may convert electricity from the primary wires 106 into different voltages for one or more of the secondary wires 118. Each of the secondary wires 118 may deliver electrical energy from a transformer, such as the transformer 116, to an electrical consumer. The electrical consumer may be an electrical system of a residential, commercial, or public building.

The transformer 116 and other transformers of the electrical system 102 may each be electrically coupled to one or more surge arrestors 120 (e.g., a lighting arrestor). The surge arrestors 120 may provide surge protection to the transformer 116 during electrical storms. The surge arrestors 120 may further be electrically coupled to one or more of the primary wires 106.

Additionally, the surge arrestors 120 may electrically couple to one or more fuses 130. The fuses 130 may be cutout fuses, for example. The fuses 130 may provide overload protection for components of the electrical distribution system 102 such as cables electrically coupled to the primary wires 106 including underground primary cables or cables that connect and electrically couple the primary wires 106 to the transformer 116. The fuses 130 may electrically couple to a second surge arrestor of one or more second surge arrestors 128 (e.g., second lightning arrestors).

Undesired animals, such as the undesired object 226, exhibiting undesired behavior may cause degradation to components of the electrical system 102. For example, contact between a component of the system 102 with the undesired animal or material deposited by an animal may increase a likelihood of fires and undesired, uncontrolled discharges of electrical energy, electrical arcing, and so on. The undesired object 226 may be an animal known to be prone to undesired behavior that may cause degradation to the system 102 such as birds, bats, insects, squirrels, raccoons, and so on.

As such, FIG. 1 further shows an example of a NAIL system 101 in accordance with the present disclosure for deterring undesired objects. The NAIL system 101 includes a sensor 274, a laser system 142, and a sound emitter 224. Components of the NAIL system 101 are surrounded by one or more dashed dotted lines 134.

The sensor 274 may be configured to detect the presence of an animal in the area of interest. The sensor 274 may be a passive infrared (PIR) sensor that detects infrared light, for example. Data received from the sensor 274, such as light signatures, may be used to detect motion in an area around the electrical system 102 within a threshold distance 229. The threshold distance 229 may be a range of the sensor 274, outside of which motion detection may be less accurate. The detected motion may indicate an object, which may be identified as a target as described further below.

The laser system 142 may be configured to fire a laser at a detected target. The laser system 142 may include a laser module 230, such as a diode laser. The laser module 230 may generate and project a light beam 228. The light beam 228 projected by the laser module may be a single color/wavelength of light. For example, the beam 228 projected from laser module 230 may be green and, more specifically, may have approximately 520 nanometer (nm) wavelength. It is to be appreciated, that for alternate examples the laser may be multimodal and be capable of being adjusted, such as via the control system 246, to project beams of varying colors and wavelengths and in a variety of temporal patterns. For example, one temporal pattern may include a 0.5 second burst every 5 seconds. The laser module 230 may project light in the visible spectrum and/or light that is not visible to the human eye, such as infrared and/or ultraviolet light. It is to be appreciated that for an alternative configuration, another form of beam generator (e.g., a beam projector) may be used in place of a laser. It is to be appreciated that another dissuasion device may be used in place of a beam generator or beam projector, such as a pellet gun or launcher, a liquid sprayer, or another projectile launcher that may create a negative experience for the target. The sensor 274 may be integrated within the laser system 142 or may be separate and communicatively coupled directly and/or through a control system 246 to the laser system 142.

The sound emitter 224 may be configured to generate one or more sounds 222. For example, the sound emitter 224 may be a speaker, such as a piezoelectric speaker. The laser system 142 and the sound emitter 224 may be mounted to one or more non-charged portions of the electrical distribution system 102. For example, the laser system 142 and/or the sound emitter 224 may be mounted to cross-arms 124, 125 of the first electrical pole 112. In the example shown in FIG. 1, the laser system 142 is mounted to the second cross-arm 125. However, it is to be appreciated that the laser system 142 and/or the sound emitter 224 may be mounted to another feature or component of the first electrical pole 112 such as the pole section 136 or the first cross-arm 124.

A first secondary wire 118a of the secondary wires 118 may supply the sensor 274, the sound emitter 224, and/or the laser system 142 with electrical power. Additionally, or alternatively, a solar panel 240 may be electrically coupled to and supply electrical power to the sensor 274, the sound emitter 224, and/or the laser system 142. The solar panel 240 may be mounted to the electrical pole 112, or may be mounted or integrated with the NAIL system 101.

The laser system 142 may in some examples be configured to pivot in a range of motion so as to follow motion of an identified target or distribute treatment to a defined volume of air or surface area. For example, when a moving target is detected via the sensor 274, the laser system 142 may rotate to remain directed at the target throughout the motion while the sound emitter 224 generates and broadcasts one or more sounds 222. Alternatively, the laser system 142 may be static and aimed at the center of the area to be protected.

The sounds 222 may have one or more frequencies selected to be audible to a specific desired animal species, such as the undesired object 226. Additionally or alternatively, the frequencies of the sounds 222 may be selected to be more difficult to hear or entirely inaudible to neutral animals, desired animals, and humans. Additionally, or alternatively, the sounds 222 may be designed to mimic a natural sound that may illicit a fear response in an undesired animal species. For example, the sounds 222 may mimic a predator or a wounded member of the same undesired species. Additionally, or alternatively, the sounds 222 may be selected to irritate one or more specific desired animal species.

By targeting animals with the beam 228 during and/or after emitting sounds 222, animals hearing the sounds 222 may be trained by association to avoid the sounds 222. For example, if the undesired object 226 remains within the distance 229 for at least a threshold time of emitting the sounds 222 in response to initially detecting the undesired object 226 and identifying the undesired object 226 as a target, the laser system 142 may project the beam 228 at the undesired object 226.

The sensor 274 and the laser module 230 may be contained within a housing 234. There may be an opening in the housing 234 such that the beam 228 is projectable via the laser module 230 to a target outside of the housing 234. Likewise, the sensor 274 may have features extending from and through the housing 234, such that the sensor 274 may detect motion and electromagnetic waves.

The housing 234 may be mounted to a bracket 220 via a gimbal 232. The gimbal 232 be configured to position the housing 234 at various angles relative to the bracket 220. An actuator 254 coupling the gimbal 232 to the bracket 220 may pivot the gimbal 232 in one or more directions of motion.

The NAIL system 101 may be controlled via a control system 246. The control system 246 may be internal or external to the laser system 142, or split into separate components in a combination of internal and external positions. The control system 246 may communicatively couple to electronic components of the laser system 142, the sound emitter 224, and the actuator 254 of the gimbal 232, as shown via the dotted lines 238.

The control system 246 may include a controller 249, a database 247, and a computer 251 that are communicatively coupled to each other. The computer 251 may be or include an imaging processing system for processing images created from the sensor 274. The database 247 may include a catalogue of undesired species information, such as sensor signatures and images, that may be used to identify the species of a detected animal. The database 247 may also include corresponding NAIL system 101 settings that may best deter specific undesired animals when targeted. For example, the database 247 may include specifications on the wavelength, power, or pattern of light for the beam 228 to deter a specific undesired animal and that may be generated via the laser system 142 after receiving a command signal from the control system 246.

The controller 249 and/or computer 251 may execute instructions stored on a memory of the controller 249 and/or computer 251. The controller 249 and computer 251 may store transient and non-transient data of instructions for the laser system 142. One or more instructions executed via the controller 249 and/or computer 251 may be used to generate command signals based on sensor input received from a plurality of sensors, such as the sensor 274. The command signals may cause actuators of the NAIL system 101 to adjust settings based on the sensor input. As one example, the controller 249 may send command signals to the actuator 254 of the gimbal 232 to change the direction of the beam 228. The controller 249 may also send command signals to change the color of the beam 228 generated by the laser module 230 based on user input or the suggestion of an image processor or another system of the computer. For example, if the undesired object 226 is identified to be a species of animal sensitive to green light, such as a crow, the controller 249 may send a command signal to laser module 230 to generate a green light beam. The controller 249 may also send command signals to change other settings of the laser module 230, such as shape and power of the beam 228. Further, the controller 249 may send command signals to change the fire rate or pulse rate of the beam 228 fired via the laser module 230.

Turning to FIG. 2, a schematic 200 of a second example of the electrical system 102 is shown. The schematic 200 includes a second electrical pole 312 as part of the electrical system 102.

The second electrical pole 312 includes a second pole section 322 with one or more cross-arms. For example, the second electrical pole 312 may include two cross-arms: a third cross-arm 324 and a fourth cross-arm 325. One or more second grounding wire(s) 310 may be mounted to the second pole section 322. The second electrical pole 312 may be substantially identical to the first electrical pole 112. For example, the second pole section 322 may be substantially identical to the first pole section 122; the third cross-arm 324 may be substantially identical to the first cross-arm 124; the fourth cross-arm 325 may be substantially identical to the second cross-arm 125; and the second grounding wire(s) 310 may be substantially identical to the first grounding wire(s) 110. One or more of the components described above as being part of the first electrical pole 112 may also be included in the second electrical pole 312, such as insulators 126, transformers 116, surge arrestors 120, fuses 130, and so on.

The second electrical pole 312 may be positioned within or at the threshold distance 229 from the NAIL system 101. Thus, the NAIL system 101 may reduce undesirable behavior of undesirable animals at the second electrical pole 312. In this way, the NAIL system 101 may deter undesired animals from a structure to which the NAIL system 101 is mounted as well as separate structures positioned within the range of the sensors of the NAIL system 101.

Turning to FIG. 3, it shows a third schematic 300 of the electrical distribution system 102. The electrical distribution system 102 may include a data transmission system 350, such as a long-range data transmission (LoRa) system utilizing radio signals 436 and/or wires to transmit packets of data. For example, the data transmission system may transmit low bandwidth packets of data over long ranges using long-range radio waves. The data transmission system 350 may include one or more communication units 428. Each of the communication units 428 may be mounted to a structure of the electrical distribution system 102, such as the electrical poles 112, 312.

The communication unit 428 may be communicatively coupled to the NAIL system 101, the control system 246, an internet portal 429, an antenna 405 and a satellite relay 406 via wired and/or wireless connections as indicated via dotted lines 238. The communication unit 428 may additionally be communicatively coupled to a utility monitoring center 403 via a wired or wireless connection 444.

The data transmission system 350 may send data from electrical distribution system 102 to the utility monitoring center 403. The utility monitoring center 403 may act as a monitoring center to process data communicated via the data transmission system and, more specifically, communication units, such as the communication unit 428. Decisions may be made based on data from the data transmission system at the utility monitoring center 403 via automated, unmanned systems and/or human operators.

Commands from the utility monitoring center 403 may include instructions to alter the settings of the laser system 142 and/or the sound emitter 224. For example, a command may be sent from the utility monitoring center 403 for the controller to adjust the beam 228 emitted by the laser module 230, such as by one or more of: increasing or decreasing the power of the beam 228, increasing or decreasing the wavelength of light, changing the scanning pattern, the firing pattern, and/or the firing rate, and so on. For example, there may be a first delay that is a first amount of time between detection of the undesired object 226 via the sensor 274 and generation of one or more of the sounds 222 via the sound emitter 224. There may be a second delay that is a second amount of time between detection of the undesired object 226 via the sensor 274 and generation of the beam 228 via firing the laser module 230 or generation of another deterrent via activating another dissuasion device. Commands generated at the utility monitoring center 403 may additionally or alternatively include increases or decreases in the first or second delay. Commands generated at the utility monitoring center may additionally or alternatively include increases or decreases of the volume, pitch, tone, or other aspect of the sounds 222.

For example, the utility monitoring center 403 may be communicatively coupled to the data transmission system 350 via a satellite 404 and/or an antenna 405. The antenna 405 may be communicatively coupled to the communication unit 428 via the internet portal 429, the radio signals 436, and/or the wired connection 444. Likewise, the satellite 404 may be communicatively coupled to the communication unit 428 via the internet portal 429, the radio signals 436, and/or the wired connection 444 via a satellite relay 406. For example, the antenna 405 may be a LoRa mesh network to land-based portal. For an example, wiring of the wired connection 444 may include one or more fiber optic cables. For another example, wiring of the wired connection 444 may include one or more phone lines.

Each of one or more communication units 428 may include a data recording system, a controller enclosed by a housing, and an antenna component. For example, the communication unit 428 may have a housing 430, an antenna component 432, a data recording system 434, and a second controller 440. The housing 430 may enclose electronic components of the communication unit 428, such as the data recording system 434 and the second controller 440. The antenna component 432 may include a transmitter that may generate radio signals, such as the radio signals 436. The antenna component 432 may further include a receiver that may receive radio signals generated and transmitted by transmitters and communication devices, such as from the utility monitoring center 403, the radio antenna 405, the satellite 404, and/or other communication units of the communication system.

The data recording system 434 may record data from sensors communicatively coupled to the communication unit 428, such as the sensor 274. Likewise, the data recording system 434 may record data from radio signals 436.

Data transmitted via the antenna component 432, the internet portal 429, and/or the wired connection 444 may be received by the second controller 440. The second controller 440 may be communicatively coupled to the controller 249 and/or the computer 251. Alternatively, the controller 249 and the second controller 440 may be integrated as a single component.

Turning to FIG. 4, it shows a fourth schematic 400 showing a user system 514, indicated by a dashed line 516, that is located in the monitoring center 403. The user system 514 may be communicatively coupled, via wired or wireless connections such as the radio signals 436 or the wired connection 444 of FIG. 4, to one or more of: the control system 246, the laser system 142, the sound emitter 224, other components of the electrical system 102 shown in FIGS. 1-3, as well as the communication system that includes the communication unit 428 and/or internet portal 429 of FIG. 3. For example, a computer 552 of the user system 514 may communicate with the NAIL system 101 and the control system 246 via a wired or wireless coupling. For example, the computer 552 of the user system 514 may be communicatively coupled to the NAIL system 101 and the control system 246 via a communication junction 550, as shown via the dashed lines 438.

A user 518 may provide input to the user system 514. The user input to the user system 514 may cause the monitoring center 403 to transmit information to one or more of the components communicatively coupled to the user system 514. In this way, the user 518 may adjust operational settings of various components of the system 102, including the NAIL system 101.

Additionally, the user system 514 may receive information from components communicatively coupled to the user system 514, and may generate a display of the information for view by the user 518. For example, the laser system 142 may send data to the user system 514 to generate a sensor feed 429. The sensor feed 429 may show, such as via a display device 586, a map or an image of signatures of a detected target based on data captured by the sensor 274. For example, the sensor feed 429 may show an image of heat signatures of the undesired object 226. The sensor feed 429 may show a plurality of images as a video feed.

Both the computer 552 and the display device 586 may receive electrical energy from a power source 592, such as one or more batteries, as indicates by solid lines 542. The display device 586 may display a graphical user interface (GUI) 588 and the sensor feed 528. The GUI 588 may give the user 518 options to control the NAIL system 101. The user 518 may interact with the GUI 588 via a single or plurality of inputs 590, such as a mouse and keyboard, joysticks, game console or touch screen. The user 518 may select the options from the GUI 588 to adjust the laser system 142 and/or the sound emitter 224 of the NAIL system 101. For example, the user 518 may select an option in the GUI 588 to change the color/wavelength, power, amplitude, width, and/or timing of the beam 228 fired by the laser module 230 toward a target, such as the undesired object 226. Additionally or alternatively, the user 518 may select an option in the GUI 588 to change the threshold time delay for firing the laser module 230 and generating the beam 228 after the sound emitter 224 emits the sounds 222. Further, the user 518 may select an option in the GUI 588 to change the selected sound or set of sounds for and/or increase or decrease the volume of the sounds 222 generated via the sound emitter 224.

Turning to FIG. 5, a first view 500 of an example of the laser system 142 is shown. A set of reference axes 601 are provided for comparison between views shown in FIG. 5-13. The reference axes 601 indicate a y-axis, an x-axis, and a z-axis. In one example, the z-axis may be parallel with a direction of gravity. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view. The first view 500 also shows a human operator 610 gripping the bracket 220 coupled to the laser system 142.

The laser system 142 includes a laser assembly 608 comprising the housing 234, the laser module 230, and the sensor 274. The bracket 220 includes a first member 612, a second member 614, and a truss 616 rigidly coupled and connected together. The first member 612 and the second member 614 may each be connected to the truss 616 via a rounded corner 618. The housing 234 may be mounted to the first member 612 via the gimbal 232 and the actuator 254.

The bracket 220 may also include a first eyebolt 622 and a second eyebolt 624. The first eyebolt 622 may extend from the truss 616. The second eyebolt 624 may extend from the first member 612. The eyebolts 622, 624 may allow the human operator 610 to hold the bracket 220 and by extension the laser assembly 608. For example, the human operator 610 grips the first eyebolt 622 in the first view 500. Additionally, the eyebolts 622, 624 may be configured to be gripped via a hot stick (e.g., insulated pole), thereby allowing indirect contact between the operator and the bracket 220.

For example, the second eyebolt 624 may have a threading 632, where the threading 632 may mate with a complementary threading or mating groove of the bracket 220. The bracket 220 may include a threaded hole 626, where the second eyebolt 624 may extend through the hole 626 and be fastened to the bracket 220 via the hole 626. A washer 630 comprised of an inert and non-electric conducting material, such as rubber, a polymer, or a non-metal synthetic material may be positioned at the hole 626. An insert 628 may include a sleeve portion and a head portion. The sleeve portion may be positioned around portions of the second eyebolt 624. The head portion may be positioned to abut a washer 630, where the washer 630 is sandwiched between the first member 612 and the head of the insert 628. The insert 628 and, more specifically, the sleeve portion thereof, may reduce electrical discharge and electrical flow, such as static, between the bracket 220 and the second eyebolt 624. The insert 628 may therefore reduce electrical discharge between the bracket 220 and the operator 610.

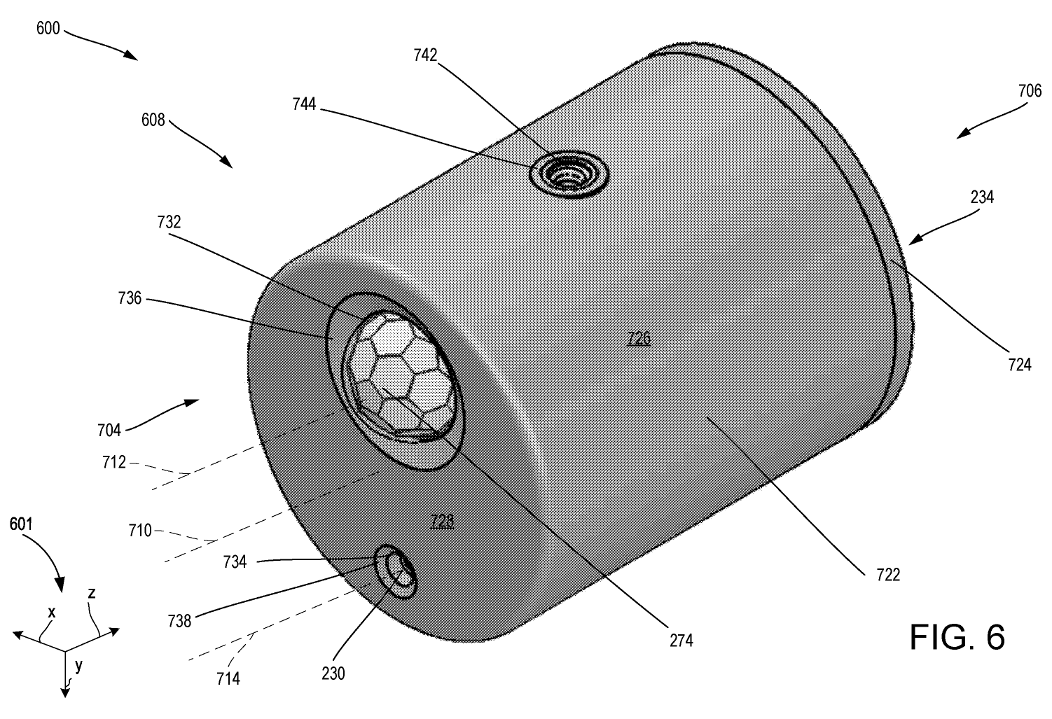

Turning to FIG. 6, it shows a second view 600 of the laser assembly 608. The laser assembly 608 has a first end 704 and a second end 706. The first end 704 is opposite the second end 706 along the z-axis. A first axis 710 may be a central axis for the laser assembly 608. The view 600 also shows a second axis 712 and a third axis 714 that are parallel with the first axis 710.

The housing 234 of the laser assembly 608 may include a housing unit 722 and a backing 724. The housing unit 722 may be hollow and cylindrical in shape, with a first surface 726 that is cylindrical and curves radially around the first axis 710, and a second surface 728 that is circular in perimeter. The backing 724 may be a cover for the housing unit 722, such that when the backing 724 is fastened to the housing unit 722, the housing 234 encloses a volume bounded by walls of the housing unit 722 and the backing 724.

The second surface 728 may include a first hole 732 positioned to hold a portion of the sensor 274. A portion of the sensor 274 may extend through and outward from the first end 704. The sensor 274, the first hole 732, a the first countersink 736 may be approximately centered around the second axis 712. The first countersink 736 may have a surface frustoconical in shape, extending radially outward from the first hole 732.

Similarly, the second surface 728 may further include a second hole 734, which may be an opening through which the laser module 230 may fire a beam at a target. The laser module 230, the second hole 734, and a second countersink 738 may be centered around the third axis 714. The second countersink 738 may have a surface that is frustoconical in shape, extending radially outward from the second hole 734.

A first insert 742 may be inserted into and housed via third hole 744. The first insert 742 may be constructed of brass, as one example. The first insert 742 may be referred to as a top mount insert, where the insert 742 is positioned at a radial top (e.g., position radially outward from the first axis 710). The first insert 742 may be rigidly physically coupled to the housing unit 722, such as via soldering. Further the first insert 742 may be adapted to receive and physically couple to a mount, such as a mount to the gimbal 232 of FIGS. 1-5. In this way, the laser assembly 608 may be mounted and fixed to the gimbal 232 via the insert 742.

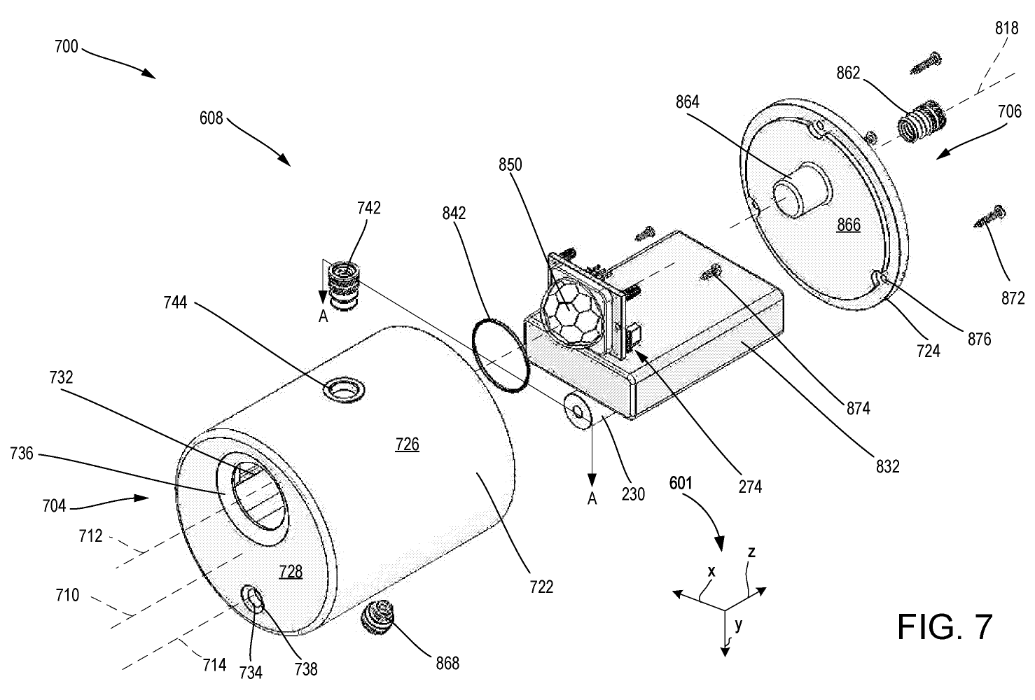

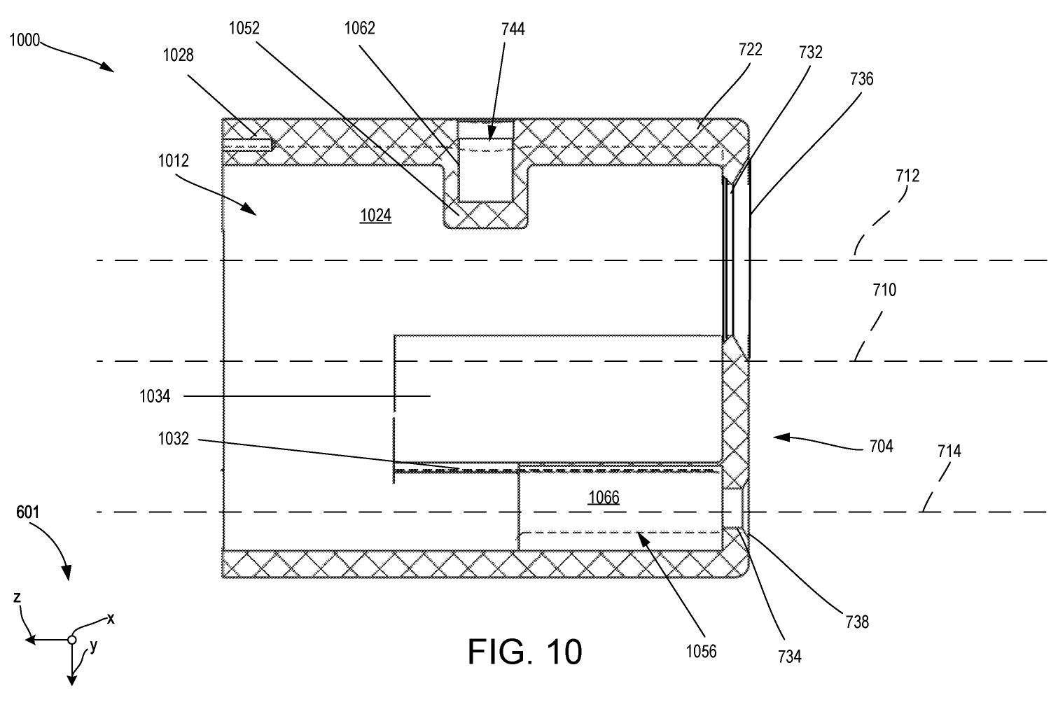

FIG. 7 shows a fourth view 700 of the laser assembly 608. The fourth view 700 is an exploded view of the laser assembly 608. A line A-A shown in FIG. 7 may section the laser assembly 608. A sectional plane taken on the line A-A may be approximately parallel with a plane of the x-axis and y-axis of the reference axes 601. The sectional plane is shown in view 1000 in FIG. 10. Additionally, the fourth view 700 shows a fourth axis 818 normal to the backing 724.

The laser assembly 608 includes a power supply, such as battery 832 that may power the laser module 230, the sensor 274, and other electronic and/or electrical components of the laser assembly. The battery 832 may be housed via the housing unit 722 and enclosed via the housing unit 722 and the backing 724 when laser assembly 608 is assembled. It is to be appreciated that a capacitor (e.g., a super capacitor) or another energy storage device may be used in addition to or in place of the battery 832 as the power source of the laser assembly 608. Additionally, or alternatively, a solar panel, such as the solar panel 240 of FIGS. 1-3 may be electrically coupled to the battery 832 and/or other energy storage device, such as the capacitor, such that the solar panel may charge the battery 832 and/or other energy storage device. Additionally, or alternatively, the power supply may include an electrical line coupled to the electrical system 102 of FIGS. 1-3, such as one or more of the secondary wires 118 shown therein. The laser module 230 and the sensor 274 may be rigidly coupled and electrically coupled to the battery 832.

The laser assembly 608 includes a seal 842 that may be positioned around portions of the sensor 274, and between a sensor head 850 of the sensor 274 and at least one surface of the housing unit 722.

Similar to the first insert 742, the laser assembly 608 includes a second insert 862. The second insert 862 may also be constructed of brass, as an example. The second insert 862 may have a universal thread, such as 1/4-20 UNIVERSAL THREADS, such that a component having complementary threading may be mounted to the laser assembly 608 via the threading interaction with the second insert 862. The second insert 862 may be received by a sleeve 864 of the backing 724. The sleeve 864 may be a socket surrounded by material formed integrally with or joined to the backing 724. The first sleeve 864 may extend axially, with respect to the fourth axis 818, from a third surface 866 of the backing 724 toward the surface 728 and into the space circumferentially surrounded by the housing unit 722.

The laser assembly 608 may include a plurality of first fasteners 872 that may fasten the backing 724 to the housing unit 722. Likewise, the laser assembly 608 may include a plurality of second fasteners 874 that may fasten the sensor 274 to the housing unit 722. The first fasteners 872 may extend through a plurality of holes 876, and fasten to the backing 724.

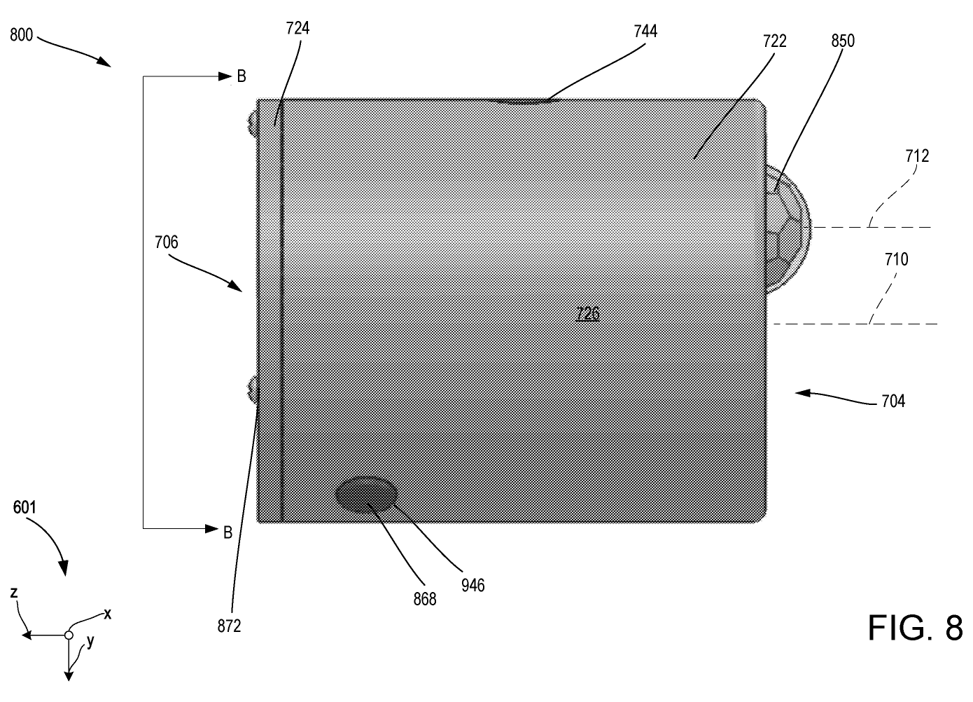

The laser assembly 608 may further include a plug 868 that may seal a hole to the housing unit 722, as described further below with reference to FIG. 8.

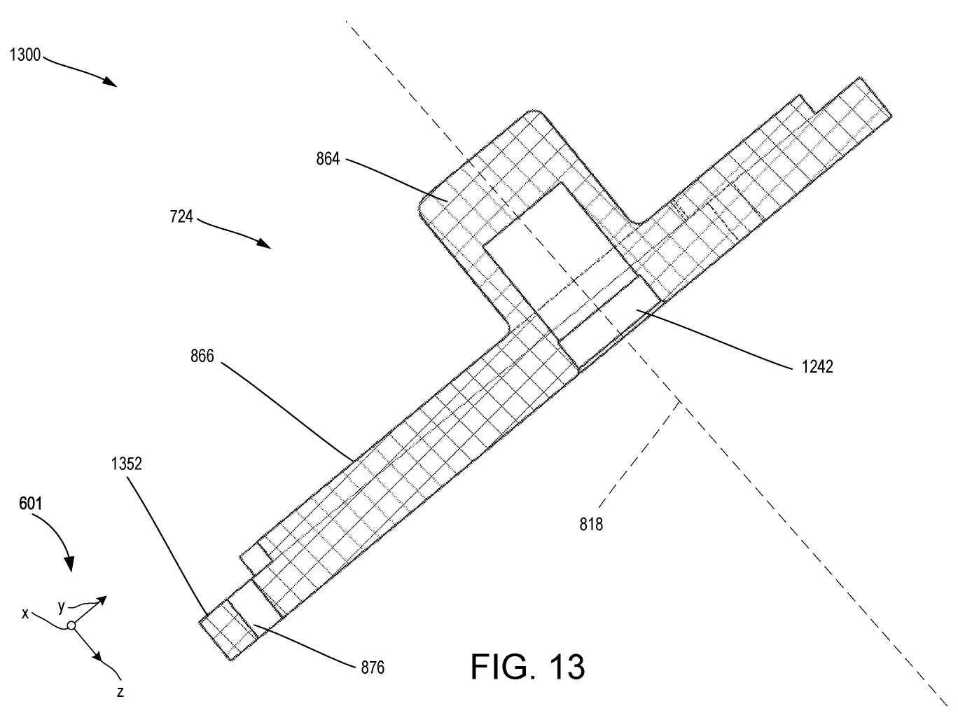

Turning to FIG. 8, it shows a fifth view 800 of the laser assembly 608. A sectional plane taken along a line B-B may be approximately parallel with a plane of the y-axis and the z-axis. A cross section along the line B-B is shown in FIG. 13.

The fifth view 800 shows a fourth hole 946 that the plug 868 may be inserted and sealed into. The fourth hole 946, when not sealed by the plug 868, may provide access to a switch having on and off positions for turning battery power of the battery 832 between on and off states in which the battery 832 respectively supplies and does not supply power to electrical components. The plug 868 may be installed after flipping the switch to the on position. The fourth hole 946 is angled and shaped to fit tools, such as a screwdriver, into the housing unit 722 for installation of components positioned within the housing unit 722.

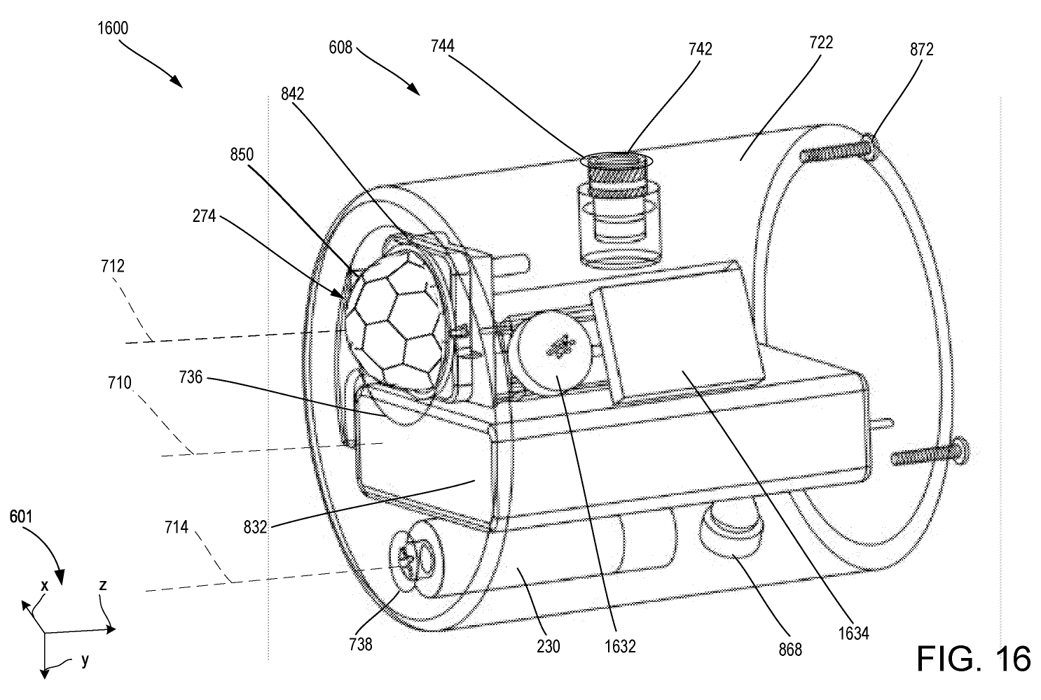

Turning briefly to FIG. 16, it shows an eleventh view 1600 of the laser assembly 608 where the housing unit 722 is transparent so as to view the components that may be housed within the housing unit 722. The housing unit 722 may house a speaker 1632 and a microprocessor 1634, in addition to the components described above such as the battery 832, the laser module 230, the sensor 274, and so on. The speaker 1632 may be an example of the sound emitter 224 of FIGS. 1-4.

The microprocessor 1634 may be a part of a larger control system, such as the control system 246 of FIGS. 1-4. The microprocessor 1634 may for example be or include the controller 249 and/or the computer 251 of FIGS. 1-4. The microprocessor 1634 may receive data from the sensor 274, such as motion signatures, light signatures, and/or sound signatures. The microprocessor 1634 may communicatively couple to and send command signals to change settings of the laser module 230, the sensor 274, the speaker 1632, and other electronic components and/or features of the laser assembly 608 based on the received data and instructions stored in memory of the microprocessor 1634, as described further with reference to the methods provided herein.

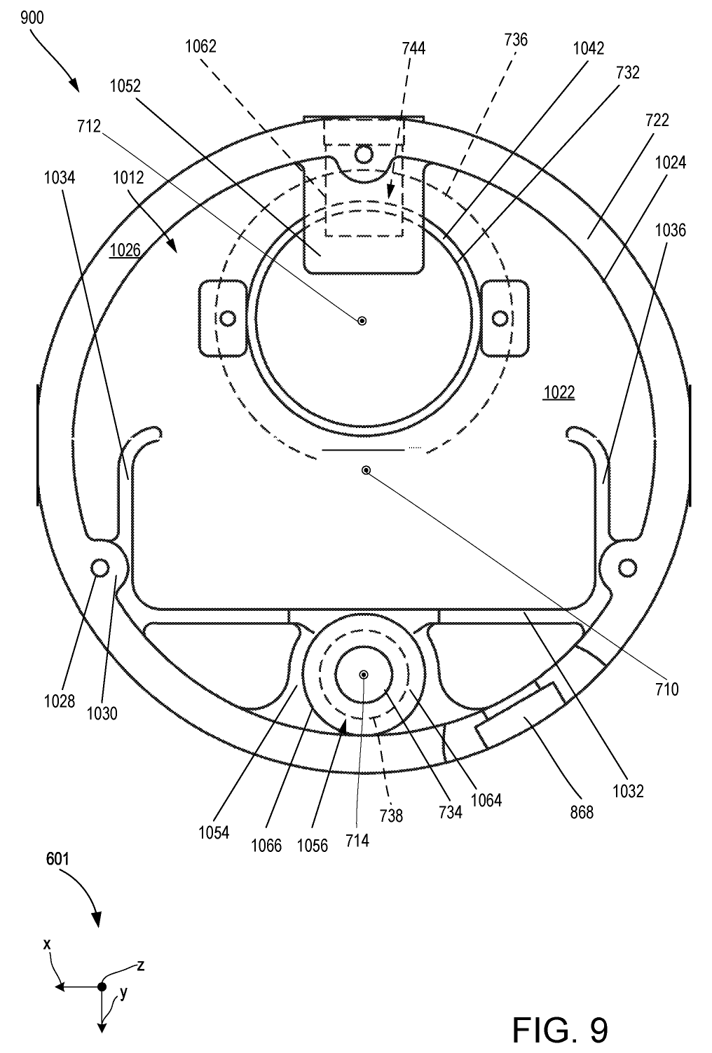

Turning to FIG. 9, it shows a sixth view 900, where the sixth view 900 is a sectional view of the housing unit 722. The sixth view 900 may be taken on the line A-A of FIG. 7.

The housing unit 722 surrounds a cavity 1012. The housing unit 722 may include a fourth surface 1022, which may be a planar circular surface that faces inward toward the cavity 1012. Likewise, the housing unit 722 may include a fifth surface 1024 that curves in a cylindrical shape around the cavity 1012. The fourth surface 1022 and the fifth surface 1024 are inner surfaces of the housing unit 722 that define the volume of the cavity 1012.

The housing unit 722 may include a flange 1026, extending radially outward from an opening into the cavity 1012. The backing 724 (not shown in FIG. 9) may rigidly couple to and seal against the flange 1026. The flange 1026 may include a plurality of holes 1028 via which the first fasteners 872 may fasten the backing 724 to the flange 1026. A plurality of bosses 1030 extending radially inward from the fifth surface 1024 may include the holes 1028. The holes 1028 may depress in an axial direction with respect to the axes 710, 712, and 714.

The housing unit 722 may further include a shelf 1032. The shelf 1032 may rigidly couple to or be connected to the fifth surface 1024, a first wall 1034, and a second wall 1036.

A third countersink 1042 may extend radially from and depress in an axial direction toward the first hole 732 with respect to the second axis 712. The third countersink 1042 may face the interior and the cavity 1012 of the housing unit 722.

The first insert 742 of FIGS. 6 and 7 may be housed via a second sleeve 1052. The second sleeve may protrude parallel with the y-axis. The second sleeve 1052 defines the volume of the third hole 744. More specifically a plurality of first inner surfaces 1062 of the second sleeve 1052 may define the volume of the third hole 744.

A third sleeve 1054 may curve around a fifth hole 1056. A second inner surface 1064 and a third inner surface 1066 of the third sleeve 1054 may define the shape of the fifth hole 1056. The second inner surface 1064 may extend radially from the second hole 734. The third inner surface 1066 may curve radially around the fifth hole 1056 and be cylindrical in shape.

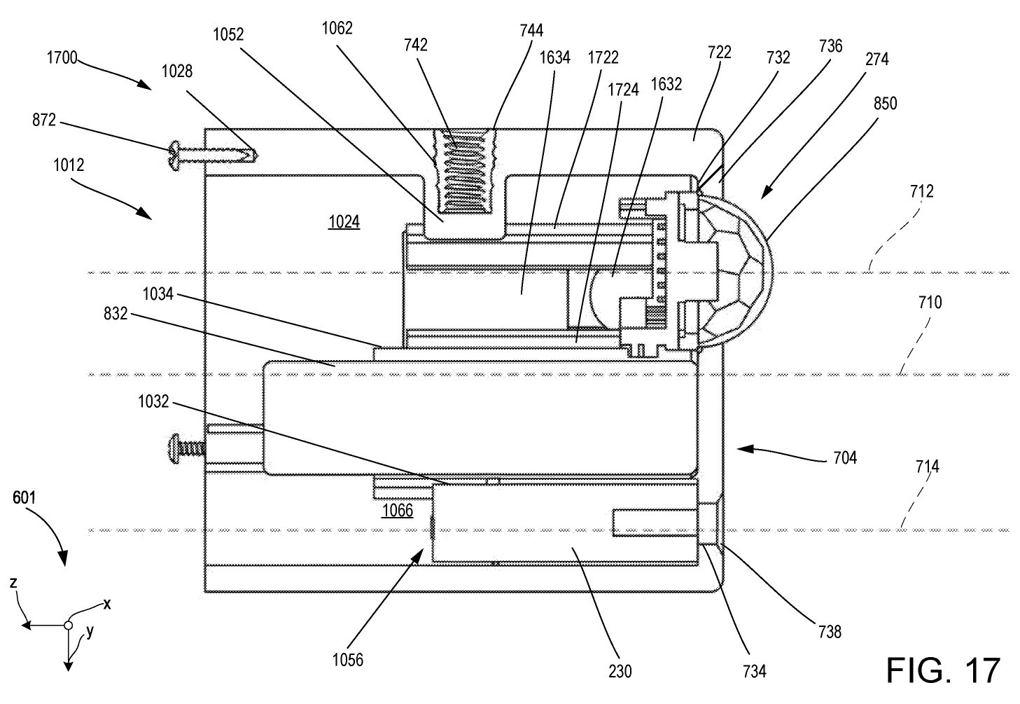

Turning to FIGS. 10 and 17, a seventh view 1000 and a twelfth view 1700 are respectively shown. The seventh view 1000 is a sectional view of the housing unit 722, taken on line B-B of FIG. 8. The twelfth view 1700 shows the sectional view of the housing unit 722 along with components housed therein.

The sensor 274 may be positioned above and may be supported in part via features of the housing unit 722, such as the first wall 1034. The battery 832 or other energy storage device may be supported via the shelf 1032. The first wall 1034 and the second wall 1036 may contact and support the battery 832, reducing movement of the battery 832 and components or features rigidly coupled thereto along the x-axis of the reference axes 601.

The laser module 230 may be housed via and loaded into the fifth hole 1056, and the laser module 230 may be supported and contacted via the third sleeve 1054.

Additionally, the speaker 1632 and the microprocessor 1634 may be mounted to and supported by a first beam 1722 and a second beam 1724. Said in another way, the speaker 1632 and the microprocessor 1634 may be fixed in place via the first beam 1722 and/or the second beam 1724.

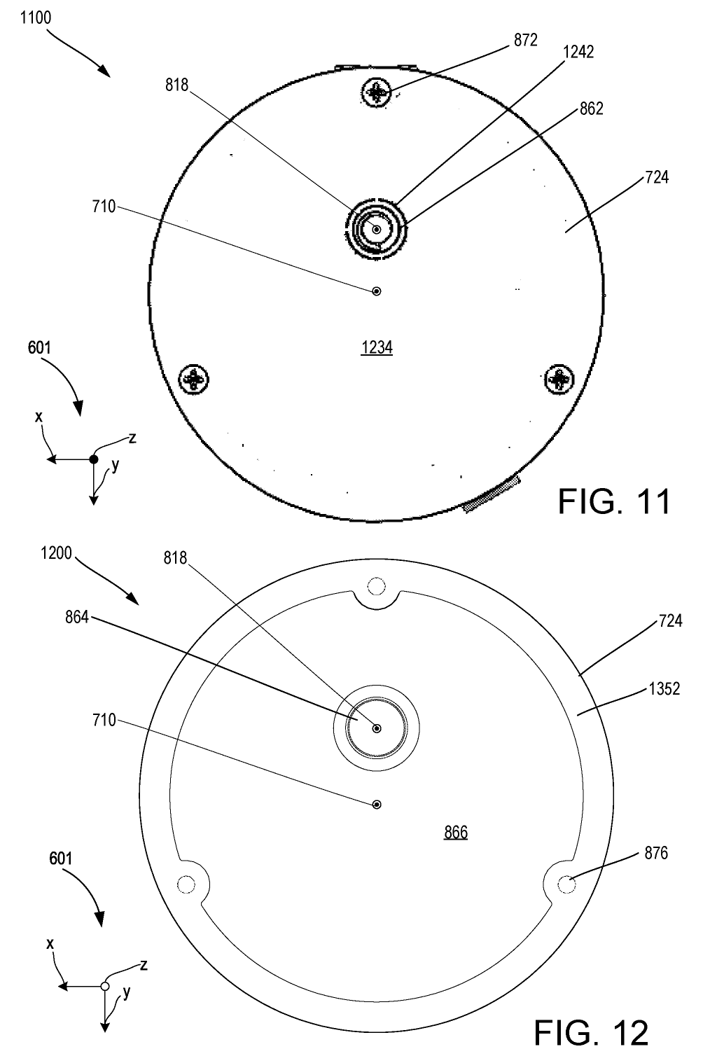

Turning to FIGS. 11 and 12, an eighth view 1100 and a ninth view 1200 of the backing 724 are respectively shown. The eighth view 1100 is a top view of the backing 724 and the ninth view 1200 is a bottom view of the backing 724.

The backing 724 has a sixth surface 1234 that is circular in shape and area save for a sixth hole 1242. The sixth hole 1242 depresses into the sixth surface 1234 in an axial direction with respect to the fourth axis 818. The sixth hole 1242 may also be positioned radially around the fourth axis 818. The second insert 862 may be positioned in the sixth hole 1242. The first sleeve 864 may curve around the sixth hole 1242. The backing 724 includes a second flange 1352 positioned around the third surface 866. The holes 876 may depress into and extend through the second flange 1352.

FIG. 13 shows a tenth view 1300 of the backing 724. The tenth view 1300 is a sectional view that may be taken on line B-B of FIG. 8. The tenth view 1300 shows the third surface 866 may be raised from the second flange 1352 in an axial direction with respect to the first axis and the fourth axis 818.

Turning to FIGS. 18A-19G, another example of a deterrent system 1800 is shown. FIGS. 18A and 18B show a perspective view and a side view, respectively, of the assembled deterrent system 1800. FIGS. 19A-19G show various individual components of the deterrent system 1800. The deterrent system 1800 may be an example of the NAIL system 101 described above.

The deterrent system 1800 includes a housing 1802. The housing 1802 may be constructed of nylon, as an example. The housing 1802 is shown as transparent in FIGS. 18A and 18B so as to view components housed therein. The housing 1802 is further shown in FIG. 19A.

The deterrent system 18000 further includes a face plate 1804, which is shown in FIG. 19B. The face plate 1804 may fasten to the housing 1802 via one or more fasteners 1824 to enclose and house components such as a sensor (e.g., motion sensor such as a PIR sensor), a laser, a sound emitter (e.g., magnetic speaker), a microprocessor, and a battery. The housing 1802 and face plate 1804 may further enclose and house additional components such as a printed circuit board (PCB) battery holder electrically coupled to the battery, a laser O-ring for sealing to the laser, and a sensor O-ring for sealing the sensor. A face plate seal 1816 may be disposed along an interface at a perimeter of the face plate 1804 where the housing 1802 and the face plate 1804 are in face-sharing contact with each other. The face plate seal 1816 may prevent environmental matter such as debris and moisture from entering the housing and degrading the components housed therein.

The deterrent system 1800 further includes a mounting bracket assembly 1830 for mounting the deterrent system 1800 to infrastructure, such as the electrical pole 112 of FIGS. 1-3. The mounting bracket assembly 1830 may include a series of brackets attached to each other in a way that enables various orientations of the deterrent system via rotational adjustments at connections between the brackets. For example, the mounting bracket assembly 1830 may include a housing mount bracket 1832, an angle bracket 1834, a pair of adjustment brackets 1836, and a cross-arm mount 1838.

The cross-arm mount 1838, which is shown in FIG. 19D, may be an example of the bracket 220. The cross-arm mount 1838 may include a first member 1852, a second member 1854, and a truss 1856 rigidly coupled and connected together. The first member 1852 and the second member 1854 may each be connected to the truss 1856 via a rounded corner 1858. The first and second members 1852, 1854 may be parallel to one another and normal to the truss 1856. The cross-arm mount 1838 may also include a first eyebolt 1860 having a nut flange 1862 and a protrusion 1864 extending from the truss 1856. The first eyebolt 1860 may be adapted to clamp the mounting bracket assembly 1830 to a cross-arm of an electrical pole, such as one of the cross-arms described with reference to FIGS. 1-3. The shape of the cross-arm mount 1838 and inclusion of the first eyebolt 1860 provide adaptability to various cross-arm dimensions and shapes as well as adjustable clamping force.

The housing mount bracket 1832, which is shown in FIG. 19E, maybe fastened to the housing 1802 via one or more fasteners 1866. A seal 1868 may be positioned to seal an interface between the housing 1802 and the fasteners 1866. The housing mount bracket 1832 may include a first portion 1870 and a second portion 1872. The first portion 1870 may be in face-sharing contact with the housing 1802, and the second portion 1872 may be in face-sharing contact with the angle bracket 1834. The second portion 1872 may be physically coupled to the angle bracket 1834 via one or more fasteners 1876. The first and second portions 1870, 1872 may be approximately normal to each other. The first portion 1870 includes first holes 1950 for the fasteners 1866 and the second portion 1872 includes second holes 1952 for the fasteners 1876.

The angle bracket 1834, which is shown in FIG. 19G, may pivotably couple to both the housing mount bracket 1832 and the cross-arm mount 1838. For example, the housing mount bracket 1832 may be fastened to the angle bracket 1834 via a first rotatable joint 1880 that is pivotable around a first axis 1882, and the cross-arm mount 1838 may be fastened to the angle bracket 1834 at a second rotatable joint 1884 that is pivotable around a second axis 1886. The first rotatable joint 1880 includes a second eyebolt 1892 and a first adjustment bracket 1836a of the adjustment brackets 1836, and the second rotatable joint 1884 includes a third eyebolt 1894 and a second adjustment bracket 1836b of the adjustment brackets 1836. One of the adjustment brackets 1836 is shown in FIG. 19F.

The angle bracket 1834 may include an anchor hole 1972, an arched hole 1974, and an elongated hole 1976 for each of the rotatable joints 1880, 1884. The anchor holes 1972 may be centered around the respective axis of rotation. The arched holes 1974 may curve around the respective axis of rotation. The anchor holes 1972 and arched holes 1974 of each joint may be formed into the same plane of the angle bracket 1834. The elongated holes may be formed into perpendicular planes to the corresponding anchor holes 1972 and arched holes 1974. The eyebolts 1892 and 1894 may extend through the elongated holes 1976 and eyebolt holes 1962 in the adjustment brackets 1836. Pivoting fasteners 1896 may each extend through the corresponding anchor holes 1972 and openings in the housing mount bracket 1832 and the cross-arm mount 1838. Positioning fasteners 1898 may each extend through the corresponding arched holes 1974 and positioning holes 1964 in the corresponding adjustment brackets 1836.

By tightening and loosening the second and third eyebolts 1892, 1894, sliding the second and third eyebolts 1892, 1894 along the elongated holes 1976, and adjusting the positions of the fasteners 1898 along the arched holes 1974, the angle bracket 1834 may rotate relative to the housing mount bracket 1832 and the cross-arm mount 1838. The eyebolts 1860, 1892, 1894 and the protrusion 1864 may be adapted to be grabbed by a human operator directly and/or via a hot stick for adjustment of the mounting bracket assembly 1830 and therefore adjustment of the sensor field of detection and beam angle from the laser. In this way, the rotatable joints 1880, 1884 allow various of the housing 1802 relative to the cross-arm mount 1838 via rotation about the first and second axes 1882, 1884.

The first and second axes 1882, 1884 may be normal to each other, as the respective anchor holes 1972 centered about the first and second axes 1882, 1884 may be located on normal planes of the angle bracket 1836. Additionally, a beam 1899, which may be the beam 228 described above, may be oriented normal to the first axis 1882.

The mounting bracket assembly 1830 may further include a solar panel mount 1840, which is shown in FIG. 19C, to which a solar panel 1842 may be attached via one or more fasteners 1843. The solar panel 1842 may be an example of the solar panel 240. The solar panel mount 1840 may include a panel section 1844 and an extension 1846. The panel section 1844 and extension 1846 may be integrally formed portions of the solar panel mount 1840. The panel section 1844 and extension 1846 may be planar and at a non-zero angle to each other. The angle between the panel section 1844 and extension 1846 may be adjustable to optimize the solar panel 1842 position relative to the direction of incident sunlight to increase solar energy capture. The solar panel mount 1840 may be attached to the cross-arm mount 1838 via one or more fasteners 1848 extending through holes in the extension 1846 and the truss 1856 of the cross-arm mount 1838. It is to be appreciated that the fasteners of the mounting bracket assembly 1830 such as fasteners 1824, 1844, 1848, 1866, 1876, 1896, 1898 may be any appropriate components suitable for attaching the referenced fastened parts allowing fixed attachment, pivotable rotation, or other fastening relationship as described above.

Turning to FIG. 14, it shows a flowchart of a method 1400 for using a NAIL system of the present disclosure, such as NAIL system 101, including a laser system and a sound emitter, to autonomously monitor and deter targeted objects, such as individuals of an undesired species of animal, from an area. More specifically, method 1400 may be used to deter birds or other animals that are undesired from an area around electrical infrastructure within a threshold distance. The electrical infrastructure may be part of an electrical distribution system, such as the electrical distribution system 102 of FIGS. 1-3. The laser system and the sound emitter, may be the laser system 142 and the sound emitter 224, respectively of FIGS. 1-4.

Method 1400 may be performed via constructing and sending command signals via a control system, such as the control system 246 of FIGS. 1-4 including computer 251 and/or controller 249 of FIGS. 1-4, and/or microprocessor 1634 of FIG. 16. More specifically, method 1400 may be stored as instructions in transitory or non-transitory memory of a control system, such as the control system 246 of FIGS. 1-4 including computer 251 and/or controller 249 of FIGS. 1-4, and/or microprocessor 1634 of FIG. 16. One or more processors of the control system may execute the instructions to adjust the NAIL system in accordance with method 1400.

At 1402, method 1400 includes adjusting a position of the deterrent system, such as an orientation relative to the infrastructure to which the system is mounted, via an actuator. For example, adjusting the position of the deterrent system may include adjusting a gimbal, or rotating a mounting bracket assembly in one or more directions. Adjusting the position of the deterrent system may allow a sensor of the laser system to detect motion over an area greater than a view cone of the sensor. Alternatively, method 1400 may include having the deterrent system remain stationary such that a sensor continuously scans an area within the view cone of the sensor. The sensor may be capable of detecting motion. In at least some examples, the sensor may be or include a PIR sensor. Additionally or alternatively, the sensor may be or include one or more cameras, including visual cameras adapted to capture colored or black and white images as well as thermal cameras adapted to capture heat maps. Additionally or alternatively, the sensor may include a PIC sensor, audio sensor, and/or other type of sensor. The position of the deterrence system may be adjusted continuously or intermittently. Additionally, or alternatively, the position may be adjusted in response to detected motion or other stimuli.

At 1408, method 1400 includes determining whether motion is detected via the sensor. If motion is not detected (NO at 1408), method 1400 returns to the start, such that the position of the deterrent system continues to be adjusted at least until motion is detected. If motion is detected (YES at 1408), method 1400 continues to 1410. At 1410, method 1400 includes marking the detected object in motion as a target and tracking the object. Tracking the target may include positioning the deterrent system via the actuator configured to cause rotation about one or more axes according to a detected location of the target. For example, the actuator 254 of the gimbal 232 may cause the deterrent system to follow the motion of the target, and to remain stationary and aimed at the target when the target is not in motion. As another example, an actuator may cause pivoting rotation about the first and/or second axes 1882, 1884 in the deterrent system 1800. Tracking the target may enable the deterrent system to maintain the target within the field of detection of the sensor, until the target is outside of the threshold distance.

Method 1400 continues to 1444 and includes emitting one or more sounds toward the target via the sound emitter. The sound or sounds may include the sounds 222 of FIGS. 1-4. The sound or sounds generated and directed via the sound emitters may mimic noises of a natural or human phenomena that may frighten, startle, or deter an undesired species of animal, such as sound associated with a predatory animal. By designing the sound to be particularly bothersome or frightening to a specific species, the sounds may specifically deter undesired species, while neutral and desired species may not have a negative experience due to the sound. Alternatively, the sound may be neutral, aside from a trained association in the mind of the individual target animal with a negative experience, which may result from a prior encounter with the NAIL system, as described below. The sound emitter may be a parabolic sound emitter or different type of sound emitter configured to emit a targeted sound directed at the target. Alternatively, the sounds may be broadcasted generally throughout the surroundings of the sound emitter, without specifically directing the sounds at the target.

After emitting the sound or sounds, method 1400 continues to 1446 and includes beginning a delay for firing the laser. The delay is a period of time between emission of the sound or sounds and firing of the laser (subsequently at 1454), unless the target leaves the area surrounding the NAIL system, such as outside of threshold distance 229 from NAIL system 101. The delay may be a fixed pre-determined amount of time. After the delay period, the method 1400 may proceed. In some examples, the delay may be an adaptable period of time. For example, a triggering event may cause a preemptive end to the delay. As a few more specific examples, the triggering event may include the detected target moving closer to the sensor, being less than or equal to a second shorter threshold distance from the NAIL system, exceeding a threshold number of sightings (e.g., detections) after the sound or sounds are emitted, and so on. In response to the end of the predetermined delay period or the triggering event, method 1400 proceeds to 1452. It is to be appreciated, that for an alternate example of method 1400, the delay for firing the laser may begin at the time the object is marked as a target at 1410, before emitting sounds at 1444.

At 1452, method 1400 includes determining whether the target left an area monitored via the NAIL system. If the target is further than the threshold distance from the sensor it may be determined that the target has left the area monitored by the NAIL system. When the target has left, the target either is undetectable via the sensor of the laser system, or the target is far enough away from the infrastructure that undesirable behavior of the target may not degrade the infrastructure.

If the target left (YES at 1452), method 1400 proceeds to 1440. At 1400, method 1400 includes stopping tracking the target. Alternatively, if the target has not left (NO at 1452), method 1400 continues to 1454. At 1454, method 1400 includes firing the laser at the target. In this way, the laser may be fired in instances where the undesired animal lingers within the threshold distance for at least the duration of the delay, or causes one of the triggering events that may shorten the delay. The intensity of the laser beam may be proportional to the distance between the animal and laser and/or to the duration that the animal is within the threshold distance. For example, the intensity of the laser beam may increase as the animal moves closer to the sensor. As another example, the intensity of the laser beam may increase until the animal leaves the area monitored by the sensor. In this way, the animal may experience stronger aversion when located closer to the system and when remaining in the area for a longer period of time. The laser may not be fired at the target if the target leaves (e.g., travels further than the threshold distance from the sensor) before the end of the delay and does not cause any of the triggering events. In this way, animals may vacate the area monitored by the NAIL system in response to the sounds without being targeted by the laser, especially after encountering the NAIL system several times and forming a trained association of the negative experience of the laser with the sounds. After 1440 or 1454 the method 1400 returns to the start.

Turning to FIG. 15, it shows a method 1500 for operating a NAIL system of the present disclosure, such as NAIL system 101, to monitor and deter targeted objects, such as individuals of an undesired species of animal, from an area. More specifically, method 1500 may be used to deter birds or other animals that are undesired (e.g., may exhibit undesirable behavior) from an area around electrical infrastructure within a threshold of distance. Method 1500 includes at least some steps of method 1400 of FIG. 14, which may not be repeated for brevity.

Method 1500 includes 1402, followed by 1408. As described above, if motion is detected (YES at 1408), method 1500 includes 1410. After 1410 where the motion source (e.g., moving object) is marked as a target, method 1500 proceeds to 1512. At 1512, method 1500 includes recording signatures from the target via one or more sensors of the NAIL system. For example, the sensors may include a PIC and/or PIR sensor, and the corresponding signatures may be wavelengths of light and their intensities. Additionally or alternatively, the sensors may include an audio sensor, where the corresponding signatures are audio signatures (e.g., sound signatures) recorded from the target via the audio sensor. The signatures may include electromagnetic and/or audio signatures, and the signatures may be used to identify the moving object in subsequent steps of method 1500.

At 1514, method 1500 includes identifying the target using a trained processing system of the control system, such as software of the computer 251 of FIGS. 2-5. The trained processing system may include an ML component, such as a neural network, or an algorithm to infer the species of an animal based on the detected and recorded signatures. The ML component may be trained on real or synthetic images. Real images may be generated, for example, from a map of electromagnetic wavelength signatures specific to an animal species detected by a sensor of the laser system. Likewise, real images may be generated from frames of digital video taken from a camera of the laser system. Synthetic images may be created using sensors and cameras separate from the laser system or generated artificially, such as from a model. Synthetic images may simulate a map of electromagnetic wavelength signature specific to an animal species, and/or may include digital photos and frames of digital video. Synthetic images may be uploaded to the ML component of the laser system for training and may simulate images taken by the laser system. Likewise, the ML component may be trained on real or synthetic audio segments.

At 1516, which is included in 1514, method 1500 includes constructing images and/or audio segments from the detected and recorded signatures (e.g., electromagnetic signatures, audio signatures, etc.). Any suitable algorithm for constructing images and audio segments from the raw data signatures detected via the one or more sensors may be used. Creating the signatures to the images and/or audio segments may convert the detected features of the target into a format comparable to previously captured images and/or audio segments of known undesired species stored in a database such as database 247 of FIGS. 1-4.

At 1532, which is included in 1514, method 1500 includes retrieving images and/or audio recordings from the database. The retrieved images and/or audio recordings may be specific to one or more undesired species (e.g., species likely to exhibit undesirable behavior that may cause degradation to the infrastructure). The retrieved images and/or audio recordings may be related to signatures of the target species recorded while training the ML model. The order of steps 1516 and 1532 may be different in other examples. For instance, creating and retrieving the corresponding images may occur concurrently, as parallel computer processes.

At 1534, which is included in 1514, method 1500 includes comparing the images and/or audio segments created at 1516 of the detected target to the images and/or audio recordings retrieved from the image database at 1532 of undesired species. The ML component may take the images and/or audio recordings created at 1516 and retrieved at 1532 as inputs and may output an identified species of the target, and/or a simple indication (e.g., yes/no) as to whether the moving object is an undesired species. For example, the trained processing system may make the determination as to whether the signatures of the target sufficiently match the information stored in the database of species pre-identified as undesirable species. The trained processing system may determine the signatures of the target sufficiently match stored signatures if a level of likeness is above a threshold, such as an 80% match.

The method 1500 continues 1538 and includes determining whether the target is an undesired animal based on the output of the trained processing algorithm. If the trained processing algorithm determines the target is not an undesired animal from the database (NO at 1538) method 1500 proceeds to 1440.

If the target is identified by the trained processing system as an undesired animal YES at 1538), method 1500 proceeds to 1444. Steps 1400, 1444, 1446, 1452, and 1454 may occur as described above with reference to method 1400. Additionally, the sound, and laser output formula, if fired, may be tailored to the identified species. In examples where the output of the trained processing system includes a specific species, the controller may look up parameters of the sound and laser that may be most effective at deterring the specific species. The parameters for the beam that may be adjusted according to the species may include wavelength/color, power, pattern, timing (e.g., duration of the delay, duration of each component of a multi-color sequence), and so on. The parameters for the sounds that may be adjusted according to the species may include pitch, tone, decibel, pattern, volume, and so on. The controller may use a lookup table stored in memory of the controller taking the species as input to find the parameters, and send command signals to the actuators (e.g., sound emitter and laser system) to adjust accordingly.

As a more specific example, known food chains and species relationships may be used to specify the sound emitted at 1444 to the species output of the trained processing system. For instance, a first undesired species may be most likely to flee in response to hearing a sound mimicking a first predator of the first species, and a second undesired species may be most likely to flee in response to hearing a different sound mimicking a second predator of the second species. Thus, upon detection and identification, via the sensor and the trained processing system, respectively, of a member of the first undesired species, the controller may command emission of the sound mimicking the first predator at 1444, rather than a sound mimicking the second predator or other different sound. Similarly, upon detection and identification of a member of the second undesired species, the controller may command emission of the sound mimicking the second predator at 1444, rather than a sound mimicking the first predator or other different sound. Likewise, in an example where the first undesired species is particularly sensitive to a first color of light and the second undesired species is particularly sensitive to a second color of light, upon detection and identification of the first or second undesired species, the controller may command the laser system to generate a beam of the corresponding first or second color of light, respectively.

The technical effect of the systems and methods herein is an increased efficacy and efficiency of animal deterrence. For example, enhanced selectivity of sound and laser generation to target undesired species while not reacting to desired and neutral animal species, humans, and inanimate objects (e.g., falling leaves, pinecones, and other natural objects) may reduce power consumption of the deterrent system. To elaborate, by specifically inhibiting sound emission and laser generation in response to identifying a target as not being an undesired species, extraneous sounds and laser beams may be reduced. Further, tailoring aspects of the sounds and light beam to the identified species may increase a likelihood that the animal is deterred and decides to leave the area in response to the sound and/or laser.

The disclosure also provides support for a deterrent system mounted to infrastructure, comprising: a laser, a sensor, a sound emitter, a housing that houses the laser, the sensor, and the sound emitter, and a control system including a controller, where the control system is communicatively coupled to the laser, the sensor, and the sound emitter. In a first example of the system, the housing is mounted to and positionable via a gimbal. In a second example of the system, optionally including the first example, the gimbal and an actuator are fixed to a bracket, and the bracket mounts the deterrent system to the infrastructure. In a third example of the system, optionally including one or both of the first and second examples, the housing includes a housing unit and a backing enclosing a cavity where the laser and sensor are housed. In a fourth example of the system, optionally including one or more or each of the first through third examples, the infrastructure includes a pole with a cross-arm, and a mounting bracket assembly of the deterrent system is configured to mount to and rigidly couple to the cross-arm. In a fifth example of the system, optionally including one or more or each of the first through fourth examples, the laser is a laser diode. In a sixth example of the system, optionally including one or more or each of the first through fifth examples, the sensor includes a passive infrared sensor and/or a photon integrated circuit. In a seventh example of the system, optionally including one or more or each of the first through sixth examples, the sensor includes an audio sensor.

The disclosure also provides support for a method for deterring animals from infrastructure via a deterrent system, comprising: detecting motion of a target via a sensor of the deterrent system, tracking the target by positioning the deterrent system via an actuator according to a detected location of the target, emitting a sound toward the target via a sound emitter of the deterrent system, and firing a beam at the target via a laser of the deterrent system in response to detecting the target after a delay or in response to a triggering event. In a first example of the method, the method further comprises: determining whether the target is an undesired species based on electromagnetic and/or audio signatures recorded from the target via the sensor in comparison to signatures of a plurality of species stored in a database communicatively coupled to a controller of the deterrent system. In a second example of the method, optionally including the first example, the method further comprises: adjusting the sound and the beam based on an identified species of the target, where the identified species is determined via a trained processing system comprising a machine learning component. In a third example of the method, optionally including one or both of the first and second examples, the beam is not fired in response to determining via a trained processing system that the object of interest is a non-target species. In a fourth example of the method, optionally including one or more or each of the first through third examples, the triggering event includes the target moving closer to the sensor. In a fifth example of the method, optionally including one or more or each of the first through fourth examples, the triggering event includes exceeding a threshold number of sightings of the target. In a sixth example of the method, optionally including one or more or each of the first through fifth examples, the laser, the sound emitter, and the sensor are housed in a housing of the deterrent system, and positioning the deterrent system via the actuator includes rotating the housing relative to a cross-arm of an electrical pole to which the deterrent system is mounted.

The disclosure also provides support for a mounting bracket assembly of a deterrent system, comprising: a housing mount bracket fastened to a housing of the deterrent system, a cross-arm mount adapted to fasten to a cross-arm of an electrical pole, and an angle bracket, where the housing mount bracket is fastened to the angle bracket at a first rotatable joint that is pivotable around a first axis, and the cross-arm mount is fastened to the angle bracket at a second rotatable joint that is pivotable around a second axis. In a first example of the system, the system further comprises: a solar panel mount fastened to a truss of the cross-arm mount. In a second example of the system, optionally including the first example, the second axis is normal to the first axis. In a third example of the system, optionally including one or both of the first and second examples, a beam emitted by a laser housed in the housing is normal to the first axis. In a fourth example of the system, optionally including one or more or each of the first through third examples, the housing houses a sensor, a laser, and a sound emitter, and the deterrent system includes instructions stored on non-volatile memory of a control system that are executable to: detect motion of a target via the sensor, track the target by positioning the deterrent system via an actuator configured to cause rotation about the first and second axes according to a detected location of the target, emit a sound toward the target via the sound emitter, and fire a beam at the target via the laser in response to still detecting the target after a delay or in response to a triggering event.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable machine and/or combination of machines. The methods may be performed by executing stored instructions with one or more logic machines (e.g., processors) in combination with one or more additional hardware elements, such as storage machines, memory, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” and so on. are used merely as labels, and are not intended to impose numerical requirements or a particular positional order on their objects. The following claims particularly point out subject matter from the above disclosure that is regarded as novel and non-obvious.

1. A deterrent system mounted to infrastructure, comprising:
a laser;
a sensor;
a housing that houses the laser and the sensor, where the sensor and the laser are positioned within the housing such that axes of the laser and the sensor are parallel with each other and with a central axis of the housing, and a battery is supported by a shelf of the housing located between the laser and the sensor; and
a control system including a controller, where the control system is communicatively coupled to the laser and the sensor.

2. The deterrent system of claim 1, further comprising a sound emitter communicatively coupled to the control system.

3. The deterrent system of claim 1, wherein the housing is mounted to, and positionable via, a gimbal, and wherein the gimbal and an actuator are fixed to a bracket, and the bracket mounts the deterrent system to the infrastructure.

4. The deterrent system of claim 1, where the housing includes a housing unit and a backing enclosing a cavity where the laser and sensor are housed.

5. The deterrent system of claim 1, where the infrastructure includes a pole with a cross-arm, and a mounting bracket assembly of the deterrent system is configured to mount to and rigidly couple to the cross-arm.

6. The deterrent system of claim 1, where the laser is a laser diode.

7. The deterrent system of claim 1, where the sensor includes a passive infrared sensor and/or a photon integrated circuit.

8. The deterrent system of claim 1, where the sensor includes an audio sensor.

9. A method for deterring animals from infrastructure via a deterrent system, comprising:
detecting motion of a target via a sensor of the deterrent system;
tracking the target by positioning the deterrent system via an actuator according to a detected location of the target;
emitting a sound toward the target via a sound emitter of the deterrent system; and
firing a beam at the target via a laser of the deterrent system in response to detecting the target after a delay or in response to a triggering event.

10. The method of claim 9, further comprising determining whether the target is an undesired species based on electromagnetic and/or audio signatures recorded from the target via the sensor in comparison to signatures of a plurality of species stored in a database communicatively coupled to a controller of the deterrent system.

11. The method of claim 9, further comprising adjusting the sound and the beam based on an identified species of the target, where the identified species is determined via a trained processing system comprising a machine learning component.

12. The method of claim 9, wherein the beam is not fired in response to determining via a trained processing system that the target is not an undesired species.

13. The method of claim 9, wherein the triggering event includes the target moving closer to the sensor.

14. The method of claim 9, wherein the triggering event includes exceeding a threshold number of sightings of the target.

15. The method of claim 9, wherein the laser, the sound emitter, and the sensor are housed in a housing of the deterrent system, and positioning the deterrent system via the actuator includes rotating the housing relative to a cross-arm of an electrical pole to which the deterrent system is mounted.

16. A mounting bracket assembly of a deterrent system, comprising:
a housing mount bracket fastened to a housing of the deterrent system;
a cross-arm mount adapted to fasten to a cross-arm of an electrical pole; and
an angle bracket, where the housing mount bracket is fastened to the angle bracket at a first rotatable joint that is pivotable around a first axis, and the cross-arm mount is fastened to the angle bracket at a second rotatable joint that is pivotable around a second axis.

17. The mounting bracket assembly of claim 16, further comprising a solar panel mount fastened to a truss of the cross-arm mount.

18. The mounting bracket assembly of claim 16, wherein the second axis is normal to the first axis.

19. The mounting bracket assembly of claim 16, wherein a beam emitted by a laser housed in the housing is normal to the first axis.

20. The mounting bracket assembly of claim 16, wherein the housing houses a sensor, a laser, and a sound emitter, and the deterrent system includes instructions stored on non-volatile memory of a control system that are executable to:
detect motion of a target via the sensor;
track the target by positioning the deterrent system via an actuator configured to cause rotation about the first and second axes according to a detected location of the target;
emit a sound toward the target via the sound emitter; and
fire a beam at the target via the laser in response to still detecting the target after a delay or in response to a triggering event.
